(19) United States
(12) Patent Application Publication
(10) Pub. No.: US 2026/0339618 A1
(43) Pub. Date: Oct. 29, 2026

(54) SELECTION OF ACTIONS ASSOCIATED WITH PLANNING PROBLEM OF AUTOMATION SYSTEM

(71) Applicant: International Business Machines Corporation, Armonk, NY (US)

(72) Inventors: Takumi Yanagawa, Tokyo (JP); YUJI WATANABE, Kawasaki-shi (JP); HIROKUNI KITAHARA, Sumida-ku (JP); Saki Takano, Tokyo (JP)

(21) Appl. No.: 19/191,407

(22) Filed: Apr. 28, 2025

(51) Int. Cl. G06F 8/30; G06F 8/41

(52) U.S. Cl. CPC G06F 8/30; G06F 8/43

(57) ABSTRACT

Selection of actions associated with a planning problem of an automation system includes executing a first set of actions of a set of actions to achieve an objective associated with a planning problem. A set of source codes corresponding to each action of the set of actions is generated based on an application of the machine learning model on each action of the set of actions. A set of complexity scores based on each source code of the set of source codes is determined. Criteria are applied on the set of complexity scores. The criteria are associated with a likelihood of execution of a second set of actions of the set of actions subsequent to the first set of actions. A second set of actions is selected from the set of actions based on the application of the criteria.

### BACKGROUND

The disclosure relates to technology planning, more particularly, to a planning problem of an automation system.

With the advancement of automation technologies, the utilization of automated systems has increased. The automated systems are widely utilized to execute various operations (such as manufacturing operations, logistics operations, communication operations, robotic manipulation operations, and data security operations). An automated system includes logic, circuitry, and interfaces that are configured to automatically execute a set of actions to achieve a goal state associated with a planning problem. The automated system is configured to execute the set of actions based on a set of predefined rules associated with the planning problem, real-time data associated with a state of the planning problem, or one or more machine learning algorithms associated with the planning problem. Further, the automation system is configured to determine a state of the planning problem with respect to the goal state. Further, the automation system is configured to iteratively determine subsequent set of actions based on the executed set of actions and a result associated with the executed set of actions. To that end, the iterative determination of the subsequent set of actions may lead to a change from an initial state of the planning process to the goal state associated with the planning problem. Examples of the automated systems include, but are not limited to, industrial automation systems, cloud automation systems, robotic automation systems, home automation systems, and the like.

### SUMMARY

In an embodiment of the disclosure, a computer-implemented method for selection of actions associated with a planning problem of an automation system is provided. The computer-implemented method further includes executing, by a computer, a first set of actions of a set of actions to achieve an objective associated with a planning problem. The computer-implemented method further includes applying, by the computer, a machine learning model on each action of the set of actions. The computer-implemented method further includes generating, by the computer, a set of source codes corresponding to each action of the set of actions based on the application of the machine learning model on each action of the set of actions. The computer-implemented method further includes determining, by the computer, a set of complexity scores based on each source code of the set of source codes. Each complexity score of the set of complexity scores is indicative of a computational complexity of a corresponding source code of the set of source codes. The computer-implemented method further includes applying, by the computer, criteria on the set of complexity scores. The criteria are associated with a likelihood of execution of a second set of actions of the set of actions subsequent to the first set of actions. The computer-implemented method further includes selecting, by the computer, the second set of actions from the set of actions based on the application of the criteria on the set of complexity scores. The computer-implemented method further includes executing, by the computer, a source code of the set of source codes to execute a set of tasks associated with the planning problem. The source code is associated with the selected second set of actions.

In various embodiments of the disclosure, a computer system for selection of actions associated with a planning problem of an automation system is provided. The computer system includes a processor set, one or more computer-readable storage media, and program instructions stored on the one or more computer-readable storage media. The program instructions are executable by the processor set to cause the processor set to execute a first set of actions of a set of actions to achieve an objective associated with a planning problem. The program instructions further cause the processor set to apply a machine learning model on each action of the set of actions. The program instructions further cause the processor set to generate a set of source codes corresponding to each action of the set of actions based on the application of the machine learning model on each action of the set of actions. The program instructions further cause the processor set to determine a set of complexity scores based on each source code of the set of source codes. Each complexity score of the set of complexity scores is indicative of a computational complexity of the corresponding source code of the set of source codes. The program instructions further cause the processor set to determine a set of code ranks based on the set of complexity scores. The set of code ranks is indicative of an order of the computational complexity associated with the corresponding source code of the set of source codes. The program instructions further cause the processor set to apply criteria on the set of code ranks. The criteria are associated with a likelihood of execution of a second set of actions of the set of actions subsequent to the first set of actions. The program instructions further cause the processor set to select the second set of actions from the set of actions based on the application of the criteria on the set of code ranks. The program instructions further cause the processor set to execute a source code of the set of source codes to execute a set of tasks associated with the planning problem. The source code is associated with the selected second set of actions.

In various embodiments of the disclosure, a computer program product for selection of actions associated with a planning problem of an automation system is provided.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 illustrates a computing environment for selection of actions associated with a planning problem of an automation system, in accordance with an embodiment of the disclosure;

FIG. 2 is a diagram that illustrates an environment for selection of actions associated with a planning problem of an automation system, in accordance with an embodiment of the disclosure;

FIG. 3 is a diagram that illustrates first exemplary operations for selection of actions associated with a planning problem of an automation system, in accordance with an embodiment of the disclosure;

FIG. 4 is a diagram that illustrates second exemplary operations for selection of actions associated with a planning problem of an automation system, in accordance with an embodiment of the disclosure;

FIG. 5 is a diagram that illustrates training of a machine learning model for selections of actions associated with a planning problem of an automation system, in accordance with an embodiment of the disclosure;

FIG. 6A is a diagram that illustrates an exemplary first user interface for selection of actions associated with a planning problem of an automation system, in accordance with an embodiment of the disclosure;

FIG. 6B is a diagram that illustrates an exemplary first user interface for selection of actions associated with a planning problem of an automation system, in accordance with an embodiment of the disclosure;

FIG. 7 is a diagram that illustrates a scenario for selection of actions associated with a planning problem of an automation system, in accordance with an embodiment of the disclosure;

FIG. 8 is a diagram that illustrates a first flowchart of a method for selection of actions associated with a planning problem of an automation system, in accordance with an embodiment of the disclosure; and

FIG. 9 is a diagram that illustrates a second flowchart of a method for selection of actions associated with a planning problem of an automation system, in accordance with an embodiment of the disclosure.

### DETAILED DESCRIPTION

With the advancement of automation technologies, the utilization of automated systems has increased. The automated systems are widely utilized to execute various operations (such as manufacturing operations, logistics operations, communication operations, robotic manipulation operations, and data security operations). An automated system includes logic, circuitry, and interfaces that are configured to automatically execute a set of actions to achieve a goal state associated with a planning problem. The automated system is configured to execute the set of actions based on a set of predefined rules associated with the planning problem, real-time data associated with a state of the planning problem, or one or more machine learning algorithms associated with the planning problem. Further, the automation system is configured to determine a state of the planning problem with respect to the goal state. Further, the automation system is configured to iteratively determine subsequent set of actions based on the executed set of actions and a result associated with the executed set of actions. To that end, the iterative determination of the subsequent set of actions may lead to a change from an initial state of the planning process to the goal state associated with the planning problem. Examples of the automated systems include, but are not limited to, industrial automation systems, cloud automation systems, robotic automation systems, home automation systems, and the like.

However, the determination of a correct subsequent set of actions with the traditional methods is challenging. Specifically, the traditional methods include a determination of an error value between a final state that is achieved based on the iterative execution of the subsequent set of actions and the goal state associated with the planning problem. Further, the traditional methods include an iterative execution of the set of actions to decrease the error value between the final state and the goal state. However, the iterative execution of the set of actions for decreasing the error between the final state and the goal state leads to a wastage of computational resources associated with the automated systems. Additionally, the iterative execution of the set of actions leads to a decrease in the error value between the final state and the goal state is time-consuming. Moreover, a determination of granular data associated with an occurrence of the error value is challenging with the determined error value between the final state and the goal state. The granular data includes one or more reasons associated with an occurrence of an anomaly that occurred during the execution of at least one action of the set of actions, a time period associated with the occurrence of the anomaly during the execution of the at least one action of the set of actions, and the like.

Hence, there is a need to increase the performance of the automated systems to execute the various operations. In an embodiment of the disclosure, a computer system may execute a first set of actions of a set of actions to achieve an objective associated with a planning problem. In various embodiments of the disclosure, the computer system is referred to as “automation system”. In an example, the computer system corresponds to a flight automation system, the planning problem corresponds to a flight automation problem associated with the flight automation system, the objective associated with the planning problem corresponds to reaching a destination of the flight automation system, and the computer system may execute a first set of control instructions to control one or more components (such as propellers, jet engines, and the like) of the flight automation system. In an additional example, the computer system corresponds to a data security automation system, the planning problem corresponds to a data security problem associated with the data security automation system, and the objective associated with the planning problem corresponds to providing data security for a database, and the computer system may execute a first set of compliance policies on data associated with the database.

The computer system may apply a machine learning model on each action of the set of actions. Further, the computer system may generate a set of source codes corresponding to each action of the set of actions based on the application of the machine learning model on each action of the set of actions. Specifically, each source code of the set of source codes corresponds to a set of code instructions for the corresponding action of the set of actions. In an example, the computer system is configured to execute the set of code instructions to execute the corresponding action of the set of actions. The utilization of the machine learning model allows the computer system to generate the set of source codes from prompt data associated with each source code of the set of source codes. The prompt data includes a description of each source code of the set of source codes, the objective associated with the planning problem, and the like. Additionally, the utilization of the machine learning model allows the computer system to reduce the need for manual coding and human errors. In an example, the set of source codes corresponds to a set of a programming language codes (such as Python scripts) corresponding to each action of the set of actions. In an additional example, the set of source codes corresponds to a set of markup language codes (such as Ansible scripts) corresponding to each action of the set of actions. Moreover, the generation of the set of source codes allows the computer system to mitigate the need for the iterative execution of the set of actions to determine a correct sequence of the set of actions with respect to the objective associated with the planning problem, thereby reducing wastage of computational resources (such as a memory, a processing power, and the like) associated with the computer system.

The computer system may determine a set of complexity scores based on each source code of the set of source codes. Each complexity score of the set of complexity scores is indicative of a computational complexity of a corresponding source code of the set of source codes. In an example, the computer system may determine source code data associated with each source code of the set of source codes. The source code data includes an identifier (such as 0001, code1, and the like) of each source code of the set of source codes, a number (such as 50, 150, 200 and the like) of code lines of each source code of the set of source codes, a count (such as 20, 40, 60 and the like) of code blocks of each source code of the set of source codes, a count (such as 5, 10, 15) of conditional blocks of each source code of the set of source codes, an amount (such as 20 megabytes, 25 megabytes, 30 megabytes, and the like) of memory for execution of each source code of the set of source codes, or a time period (such as 2 minutes, 5 minutes, 10 minutes) for the execution of each source code of the set of source codes.

Further, the computer system may generate a code complexity evaluation function based on a set of complexity factors associated with the source code data. The set of complexity factors includes a normalization factor associated with the number of code lines of each source code of the set of source codes, a normalization factor associated with the count of code blocks of each source code of the set of source codes, a normalization factor associated with the count of conditional blocks of each source code of the set of source codes, a normalization factor associated with the amount of memory for the execution of each source code of the set of source codes, or a normalization factor associated with a time period for the execution of each source code of the set of source codes. In an example, a first identifier of the first source code is 0001, a number of code lines of the first source code is 150, a count of code blocks of the first source code is 20, a count of conditional blocks of the first source code is 10, an amount of memory for execution of the first source code is 25 megabytes, or a time period for the execution of the first source code is 5 minutes.

The computer system may execute the code complexity evaluation function based on the source code data. Further, the computer system may determine the set of complexity scores based on the execution of the code complexity evaluation function. In an example, the set of source codes includes a first source code corresponding to a first action of the set of actions, and the first source code data associated with the first source code includes an identifier (#0001) of the first source code, a number (50) of code lines of the first source code, a count (20) of code blocks of the first source code, a count (5) of conditional blocks of first source code, an amount (20 megabytes) of memory for execution of the first source code, or a time period (2 minutes) for the execution of the first source code. Further, the computer system may execute the code complexity evaluation function (0.1×50+0.1×20+0.1×5+0.1×20+0.1×2) based on the first source code data. The computer system is configured to determine a first complexity score (9) based on the execution of the code complexity evaluation function (0.1×50+0.1×20+0.1×5+0.1×20+0.1×2). Similarly, the computer system may determine a respective complexity score for each source code of the set of source codes.

Additionally, the computer system may select a second set of actions from the set of actions based on the application of the criteria on the set of complexity scores. Moreover, the computer system may execute a source code of the set of source codes to execute a set of tasks associated with the planning problem. The source code is associated with the selected second set of actions. In an example, the computer system may compare the first complexity score (9) with a complexity score threshold (10). Further, the computer system may determine that the first complexity score (9) is less than the complexity score threshold (10) based on the comparison of the first complexity score with the complexity score threshold (10). The computer system may select the first action of the set of actions associated with the first source code of the first complexity score (9) based on the determination that the first complexity score (9) is less than the complexity score threshold (10). The selection of the second set of actions based on the application of the criteria on the set of complexity scores allows the computer system to select the second set of actions to be executed subsequent to the first set of actions, thereby reducing the wastage of the computer system for the determination of a correct sequence of the set of actions with respect to the objective associated with the planning problem.

In an embodiment of the disclosure, a computer-implemented method for selection of actions associated with a planning problem of an automation system is provided. The computer-implemented method further includes executing, by a computer, a first set of actions of a set of actions to achieve an objective associated with a planning problem. The computer-implemented method further includes applying, by the computer, a machine learning model on each action of the set of actions. The computer-implemented method further includes generating, by the computer, a set of source codes corresponding to each action of the set of actions based on the application of the machine learning model on each action of the set of actions. The computer-implemented method further includes determining, by the computer, a set of complexity scores based on each source code of the set of source codes. Each complexity score of the set of complexity scores is indicative of a computational complexity of a corresponding source code of the set of source codes. The computer-implemented method further includes applying, by the computer, criteria on the set of complexity scores. The criteria are associated with a likelihood of execution of a second set of actions of the set of actions subsequent to the first set of actions. The computer-implemented method further includes selecting, by the computer, the second set of actions from the set of actions based on the application of the criteria on the set of complexity scores. The computer-implemented method further includes executing, by the computer, a source code of the set of source codes to execute a set of tasks associated with the planning problem. The source code is associated with the selected second set of actions.

In various embodiments of the disclosure, the application of the criteria on the set of complexity scores further includes comparing, by the computer, each complexity score of the set of complexity scores with a complexity score threshold. The computer-implemented method further includes determining, by the computer, that at least one complexity score of the set of complexity scores is less than the complexity score threshold based on the comparison of each complexity score of the set of complexity scores with the complexity score threshold. The computer-implemented method further includes selecting, by the computer, the second set of actions associated with the source code of the at least one complexity score based on the determination that the at least one complexity score of the set of complexity scores is less than the complexity score threshold.

In various embodiments of the disclosure, the computer-implemented method further includes determining, by the computer, source code data associated with each source code of the set of source codes. The source code data includes at least one of an identifier of each source code of the set of source codes, a number of code lines of each source code of the set of source codes, a count of code blocks of each source code of the set of source codes, a count of conditional blocks of each source code of the set of source codes, an amount of memory for execution of each source code of the set of source codes, or a time period for the execution of each source code of the set of source codes. The computer-implemented method further includes generating, by the computer, a code complexity evaluation function based on a set of complexity factors associated with the source code data. The computer-implemented method further includes executing, by the computer, the code complexity evaluation function based on the source code data. The computer-implemented method further includes determining, by the computer, the set of complexity scores based on the execution of the code complexity evaluation function.

In various embodiments of the disclosure, the set of complexity factors includes at least one of a normalization factor associated with the number of code lines of each source code of the set of source codes, a normalization factor associated with the count of code blocks of each source code of the set of source codes, a normalization factor associated with the count of conditional blocks of each source code of the set of source codes, a normalization factor associated with the amount of memory for the execution of each source code of the set of source codes, or a normalization factor associated with the set of total time periods for the execution of each source code of the set of source codes.

In various embodiments of the disclosure, the computer-implemented method further includes determining, by the computer, a set of code ranks based on the set of complexity scores. The set of code ranks is indicative of an order of the computational complexity associated with the corresponding source code of the set of source codes. The computer-implemented method further includes applying, by the computer, the criteria on the set of code ranks. The computer-implemented method further includes selecting, by the computer, the second set of actions from the set of actions based on the application of the criteria on the set of code ranks.

In various embodiments of the disclosure, the application of the criteria on the set of code ranks further includes comparing, by the computer, each code rank of the set of code ranks with a code rank threshold. The computer-implemented method further includes determining, by the computer, that at least one code rank of the set of code ranks is greater than the code rank threshold based on the comparison of each code rank of the set of code ranks with the code rank threshold. The computer-implemented method further includes selecting, by the computer, the second set of actions associated with the source code of the at least one code rank based on the determination that the at least one code rank of the set of code ranks is greater than the code rank threshold.

In various embodiments of the disclosure, the computer-implemented method further includes generating, by the computer, a ranking function based on a scaling factor associated with the set of complexity scores. The computer-implemented method further includes executing, by the computer, the ranking function based on the set of complexity scores. The computer-implemented method further includes determining, by the computer, the set of code ranks based on the execution of the ranking function.

In various embodiments of the disclosure, the scaling factor corresponds to one of a normalization factor associated with a normalization of the set of complexity scores, a normalization factor associated with a mean of the set of complexity scores, a normalization factor associated with a standard deviation of the set of complexity scores, or a normalization factor associated with a log of the set of complexity scores.

In various embodiments of the disclosure, the computer-implemented method further includes receiving, by the computer, at least one action of the set of actions executed subsequent to the first set of actions. The second set of actions includes the at least one action of the set of actions. The computer-implemented method further includes determining, by the computer, an action of the second set of actions corresponding to a first code rank of the set of code ranks. The computer-implemented method further includes comparing, by the computer, the at least one action of the set of actions with the action of the second set of actions. The computer-implemented method further includes determining, by the computer, validation data for the at least one action of the set of actions based on the comparison of the at least one action of the set of actions with the action of the second set of actions. The validation data is associated with at least a classification of an accuracy of the at least one action associated with the objective. The computer-implemented method further includes outputting, by the computer, the validation data.

In various embodiments of the disclosure, the computer-implemented method further includes generating, by the computer, training data based on the validation data. The computer-implemented method further includes training, by the computer, a machine learning model based on the training data. The machine learning model is trained to determine the second set of actions.

In various embodiments of the disclosure, a computer system for selection of actions associated with a planning problem of an automation system is provided. The computer system includes a processor set, one or more computer-readable storage media, and program instructions stored on the one or more computer-readable storage media. The program instructions are executable by the processor set to cause the processor set to execute a first set of actions of a set of actions to achieve an objective associated with a planning problem. The program instructions further cause the processor set to apply a machine learning model on each action of the set of actions. The program instructions further cause the processor set to generate a set of source codes corresponding to each action of the set of actions based on the application of the machine learning model on each action of the set of actions. The program instructions further cause the processor set to determine a set of complexity scores based on each source code of the set of source codes. Each complexity score of the set of complexity scores is indicative of a computational complexity of the corresponding source code of the set of source codes. The program instructions further cause the processor set to determine a set of code ranks based on the set of complexity scores. The set of code ranks is indicative of an order of the computational complexity associated with the corresponding source code of the set of source codes. The program instructions further cause the processor set to apply criteria on the set of code ranks. The criteria are associated with a likelihood of execution of a second set of actions of the set of actions subsequent to the first set of actions. The program instructions further cause the processor set to select the second set of actions from the set of actions based on the application of the criteria on the set of code ranks. The program instructions further cause the processor set to execute a source code of the set of source codes to execute a set of tasks associated with the planning problem. The source code is associated with the selected second set of actions.

In various embodiments of the disclosure, the program instructions further cause the processor set to determine source code data associated with each source code of the set of source codes. The source code data includes at least one of an identifier of each source code of the set of source codes, a number of code lines of each source code of the set of source codes, a count of code blocks of each source code of the set of source codes, a count of conditional blocks of each source code of the set of source codes, an amount of memory for execution of each source code of the set of source codes, or a set of total time periods for the execution of each source code of the set of source codes. The program instructions further cause the processor set to generate a code complexity evaluation function based on a set of complexity factors associated with the source code data. The program instructions further cause the processor set to execute the code complexity evaluation function based on the source code data. The program instructions further cause the processor to determine the set of complexity scores based on the execution of the code complexity evaluation function.

In various embodiments of the disclosure, the set of complexity factors includes at least one of a normalization factor associated with the number of code lines of each source code of the set of source codes, a normalization factor associated with the count of code blocks of each source code of the set of source codes, a normalization factor associated with the count of conditional blocks of each source code of the set of source codes, a normalization factor associated with the amount of memory for the execution of each source code of the set of source codes, or a normalization factor associated with the set of total time periods for the execution of each source code of the set of source codes.

In various embodiments of the disclosure, to apply the criteria on the set of code ranks, the program instructions further cause the processor set to compare each code rank of the set of code ranks with a code rank threshold. The program instructions further cause the processor set to determine that at least one code rank of the set of code ranks is greater than the code rank threshold based on the comparison of each code rank of the set of code ranks with the code rank threshold. The program instructions further cause the processor set to select the second set of actions associated with the source code of the at least one code rank based on the determination that the at least one code rank of the set of code ranks is greater than the code rank threshold.

In various embodiments of the disclosure, the program instructions further cause the processor set to generate a ranking function based on a scaling factor associated with the set of complexity scores. The program instructions further cause the processor set to execute the ranking function based on the set of complexity scores. The processor instructions further cause the processor set to determine the set of code ranks based on the execution of the ranking function.

In various embodiments of the disclosure, the scaling factor corresponds to one of a normalization factor associated with a normalization of the set of complexity scores, a normalization factor associated with a mean of the set of complexity scores, a normalization factor associated with a standard deviation of the set of complexity scores, or a normalization factor associated with a log of the set of complexity scores.

In various embodiments of the disclosure, the program instructions further cause the processor set to receive at least one action of the set of actions executed subsequent to the first set of actions. The second set of actions includes the at least one action of the set of actions. The programs instructions further cause the processor set to determine an action of the second set of actions corresponding to a first code rank of the set of code ranks. The programs instructions further cause the processor set to compare the at least one action of the set of actions with the action of the second set of actions. The programs instructions further cause the processor set to determine validation data for the at least one action of the set of actions based on the comparison of the at least one action of the set of actions with the action of the second set of actions. The validation data is associated with at least a classification of an accuracy of the at least one action associated with the objective. The programs instructions further cause the processor set to output the validation data.

In various embodiments of the disclosure, the program instructions further cause the processor set to generate training data based on the validation data. The programs instructions further cause the processor set to train a machine learning model based on the training data. The machine learning model is trained to determine the second set of actions.

In various embodiments of the disclosure, a computer program product for selection of actions associated with a planning problem of an automation system. The computer program product is stored on the one or more computer-readable storage media to perform operations. The operations include executing a first set of actions of a set of actions to achieve an objective associated with the planning problem. The operations include applying a machine learning model on each action of the set of actions. The operations include generating a set of source codes corresponding to each action of the set of actions based on the application of the machine learning model on each action of the set of actions. The operations include determining a set of complexity scores based on each source code of the set of source codes. Each complexity score of the set of complexity scores is indicative of a computational complexity of the corresponding source code of the set of source codes. The operations include applying criteria on the set of complexity scores. The criteria are associated with a likelihood of execution of a second set of actions of the set of actions subsequent to the first set of actions. The operations include selecting a second set of actions from the set of actions based on the application of the criteria on the set of complexity scores. The operations include executing a source code of the set of source codes to execute a set of tasks associated with the planning problem. The source code is associated with the selected second set of actions.

In various embodiments of the disclosure, the operations further include comparing each complexity score of the set of complexity scores with a complexity score threshold. The operations further include determining that at least one complexity score of the set of complexity scores is less than the complexity score threshold based on the comparison of each complexity score of the set of complexity scores with the complexity score threshold. The operations further include selecting the second set of actions associated with the source code of the at least one complexity score based on the determination that the at least one complexity score of the set of complexity scores is less than the complexity score threshold.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or any freely propagating electromagnetic waves, electromagnetic waves propagating through a waveguide, light pulses passing through a fiber optic cable, electrical signals communicated through a wire, and/or any transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

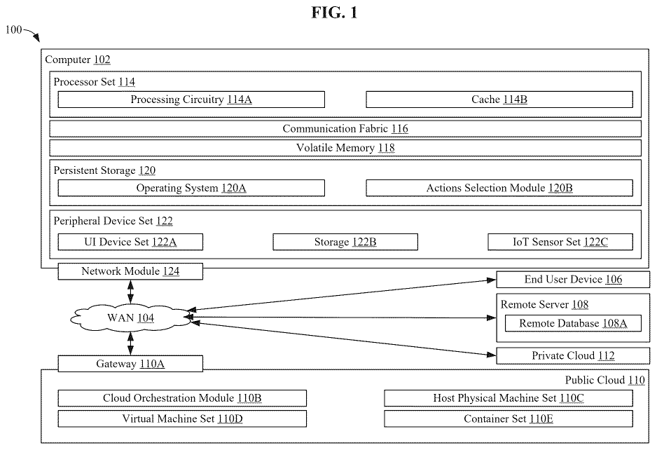

FIG. 1 is a diagram that illustrates a computing environment for selection of actions associated with a planning problem of an automation system, in accordance with an embodiment of the disclosure. With reference to FIG. 1, there is shown a computing environment 100 that contains an example of an environment for execution of at least some of the computer code/module involved in performing the methods, such as an actions selection module 120B. In addition to the actions selection module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the actions selection module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or wearable computer, a mainframe computer, a quantum computer, or any form of a computer or a mobile device now known or to be developed in the future that is configured to run a program, access a network or query a database, such as a remote database 108A. As is well understood in the art of computer technology, and depending upon the technology, the performance of a computer-implemented method may be distributed among multiple computers and/or between multiple locations. Alternatively, in this presentation of the computing environment 100, detailed discussion is focused on a single computer, specifically the computer 102, to keep the presentation as simple as possible. The computer 102 may be located in a cloud, even though it is not shown in a cloud in FIG. 1. Alternatively, computer 102 does not need to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby affect a computer-implemented method, such that the instructions thus executed will instantiate the methods specified in flowcharts and/or narrative descriptions of computer-implemented methods included in this document (collectively referred to as “the methods”). These computer-readable program instructions are stored in various types of computer-readable storage media, such as the cache 114B and various storage media discussed below. The program instructions, and associated data, are accessed by the processor set 114 to control and direct the performance of the methods. In computing environment 100, at least some of the instructions for performing the methods may be stored in the dynamic modification of the actions selection module 120B in persistent storage 120.

The communication fabric 116 is the signal conduction path that allows the various components of computer 102 to communicate among themselves. Typically, this fabric is made of switches and electrically conductive paths, such as the switches and electrically conductive paths that make up buses, bridges, physical input/output ports, and the like. Various types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not needed unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the actions selection module 120B typically includes at least some of the computer code involved in performing the disclosed methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is needed to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In an embodiment of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) configured to communicate computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collects and stores helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize the resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each cloud of the multiple clouds remains a separate and discrete entity, but the larger hybrid cloud architecture is bound together by standardized or proprietary technology that allows orchestration, management, and/or data/application portability between the multiple constituent clouds. In this embodiment of the disclosure, the public cloud 110 and the private cloud 112 are both part of a larger hybrid cloud.

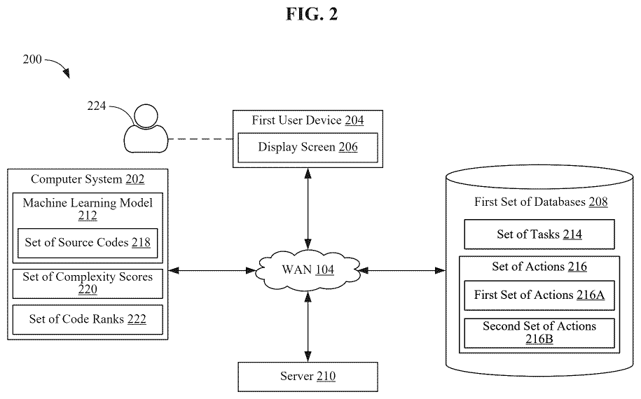

FIG. 2 is a diagram that illustrates an environment for selection of actions associated with a planning problem of an automation system, in accordance with an embodiment of the disclosure. FIG. 2 is explained in conjunction with elements from FIG. 1. With reference to FIG. 2 there is shown a network environment 200. The network environment 200 includes a computer system 202, a first user device 204 that includes a display screen 206, a first set of databases 208, a server 210, and a machine learning model 212. The first set of databases 208 is configured to store a set of tasks 214 associated with a planning problem of an automation system. In an embodiment of the disclosure, the computer system 202 is referred to as “automation system”. Specifically, each task of the set of tasks corresponds to an objective associated with the corresponding execution of a sequence of actions of the set of actions 216. Further, the first set of databases 208 is configured to store a set of actions 216 that is executed to execute the set of tasks 214. In an embodiment of the disclosure, the computer system 202 is configured to generate a set of source codes 218 corresponding to each action of the set of actions 216. In various embodiments of the disclosure, the computer system 202 is configured to determine a set of complexity scores 220 based on each source code of the set of source codes 218. In various embodiments of the disclosure, the computer system 202 is further configured to determine a set of code ranks 222 based on the set of complexity scores 220. With reference to FIG. 2, there is further shown a user 224 associated with the first user device 204 and the WAN 104 of FIG. 1. In an embodiment of the disclosure, the computer system 202 is an exemplary embodiment of the computer 102 in FIG. 1. Similarly, in an embodiment of the disclosure, the first user device 204 is an example embodiment of the EUD 106 of FIG. 1.

The computer system 202 includes suitable logic, circuitry, interfaces, and/or code that are configured to execute a first set of actions 216A of the set of actions 216 to achieve an objective associated with the planning problem. The computer system 202 is configured to apply the machine learning model 212 on each action of the set of actions 216. The computer system 202 is configured to generate the set of source codes 218 corresponding to each action of the set of actions 216 based on the application of the machine learning model 212 on each action of the set of actions 216. The computer system 202 is further configured to determine the set of complexity scores 220 based on each source code of the set of source codes 218. Each complexity score of the set of complexity scores 220 is indicative of a computational complexity of a corresponding source code of the set of source codes 218. The computer system 202 is further configured to apply criteria on the set of complexity scores 220. The criteria are associated with a likelihood of execution of a second set of actions 216B of the set of actions 216 subsequent to the first set of actions 216A. The computer system 202 is configured to select the second set of actions 216B from the set of actions 216 based on the application of the criteria on the set of complexity scores 220. The computer system 202 is further configured to execute a source code of the set of source codes 218 to execute the set of tasks 214 associated with the planning problem. The source code is associated with the selected second set of actions 216B.

Examples of the computer system 202 include but are not limited to, a server, a computing device, a virtual computing device, a mainframe machine, a computer workstation, a smartphone, a cellular phone, a mobile phone, a gaming device, or a consumer electronic (CE) device. In an example embodiment of the disclosure, the computer system 202 may be embodied as a cloud-based service, a cloud-based application, a cloud-based platform, a remote server-based service, a remote server-based application, a remote server-based platform, or a virtual computing system.

The first user device 204 may include suitable logic, circuitry, interfaces, and/or code that are configured to transmit the set of actions 216, the executed first set of actions 216A of the set of actions 216, the set of tasks 214 or any combination thereof to the computer system 202. In an embodiment, the first user device 204 may include the display screen 206. In an embodiment of the disclosure, the first user device 204 is further configured to display the set of actions 216, the executed first set of actions 216A of the set of actions 216, the set of tasks 214 on the display screen 206 associated with the first user device 204. The first user device 204 may be associated with the user 224. In an embodiment of the disclosure, the user 224 may be a person who wishes to achieve the objective associated with the planning problem based on the execution of the set of actions 216. Examples of the first user device 204 may include, but are not limited to, a computing device, a mainframe machine, a server, a computer work-station, a smartphone, a cellular phone, a mobile phone, a gaming device, a consumer electronic (CE) device, a head-mounted device, a Virtual Reality (VR) Headset, an Augmented Reality (AR) Device, a Mixed Reality (MR) Device, a Projection-based System, and/or any device with computer vision display capabilities.

The display screen 206 may include suitable logic, circuitry, and interfaces that are configured to render the set of actions 216, the executed first set of actions 216A of the set of actions 216, the set of tasks 214, or any combination thereof. In various embodiments of the disclosure, the display screen 206 may be an external display device associated with the first user device 204. The display screen 206 may be a touch screen that allows the user 224 to provide the set of tasks 214 associated with the planning problem, the set of actions 216, and the executed first set of actions 216A of the set of actions 216. The touch screen may be at least one of a resistive touch screen, a capacitive touch screen, or a thermal touch screen. In accordance with an embodiment of the disclosure, the display screen 206 may refer to a display screen 206 of a head-mounted device (HMD), a smart-glass device, a see-through display, a projection-based display, an electro-chromic display, or a transparent display. In some embodiments of the disclosure, the display screen 206 may be realized through several known technologies such as, but are not limited to, at least one of a Liquid Crystal Display (LCD) display, a Light Emitting Diode (LED) display, a plasma display, or an Organic LED (OLED) display technology, or any display device.

Each database of the first set of databases 208 may correspond to an organized collection of data that may be stored and accessed electronically from a computer system (such as the computer system 202). In an embodiment, the first set of databases 208 may be associated with the computer system 202 and may store the set of tasks 214, the set of actions 216 that includes the first set of actions 216A, and the second set of actions 216B. Each database of the first set of databases 208 may be designed to manage, store, retrieve, and update data. The structure of each database of the first set of databases 208 typically involves tables, records, and fields that can be managed through various database management systems (DBMS). Examples of each database of the first set of databases 208 may include, but are not limited to, a relational database, a Non-Structured Query Language (SQL) database, a hierarchical database, a network database, a transactional database, a data warehouse, and a distributed database.

The server 210 includes suitable logic, circuitry, interfaces, and/or code that are configured to store the set of tasks 214, the set of actions 216, or a combination thereof. In an embodiment of the disclosure, the server 210 is configured to transmit the set of tasks 214 or the set of actions 216 to the computer system 202. The server 210 can be implemented as a cloud server and may execute operations through web applications, cloud applications, HTTP requests, repository operations, file transfer, and the like. Various example implementations of the server 210 include but are not limited to, a database server, a file server, a web server, a media server, an application server, a mainframe server, or a cloud computing server. In an embodiment of the disclosure, the server 210 is implemented as a plurality of cloud-based resources distributed by use of several technologies that are well known to those ordinarily skilled in the art. A person with ordinary skill in the art will understand that the scope of the disclosure may not be limited to the implementation of the server 210 and the computer system 202 as two separate entities. In certain embodiments, the functionalities of the server 210 can be incorporated in its entirety or at least partially in the computer system 202, without a departure from the scope of the disclosure.

The machine learning model 212 may be a sophisticated piece of software that leverages natural language processing (NLP) and machine learning techniques to understand, generate, and manipulate human language. For example, the machine learning model 212 may correspond to a language model or a large language model (LLM) model that is specifically designed for tasks related to language understanding and generation on a large scale. Certain characteristics of the LLM model may include, but are not limited to, natural language understanding, text generation, semantic understanding, transfer learning, multimodal capabilities, continuous learning, and user interaction. As an example, the LLM model for language processing may be implemented using GPT, Bidirectional Encoder Representations from Transformers (BERT), and the like.

In an embodiment of the disclosure, the machine learning model 212 is configured to determine one or more positional encoding embeddings associated with the set of actions 216. Specifically, the machine learning model 212 is configured to apply an attention algorithm on the set of actions 216 to determine the one or more positional encoding embeddings associated with the set of actions 216. Each positional encoding embedding of the one or more positional encoding embeddings is a vector that is indicative of the corresponding source code of the set of source codes 218. In an embodiment of the disclosure, the computer system 202 is configured to store the machine learning model 212. In various embodiments of the disclosure, the server 210 is configured to store the machine learning model 212. In an alternate embodiment of the disclosure, the machine learning model 212 is embodied as a cloud-based service, a cloud-based application, or a cloud-based platform.

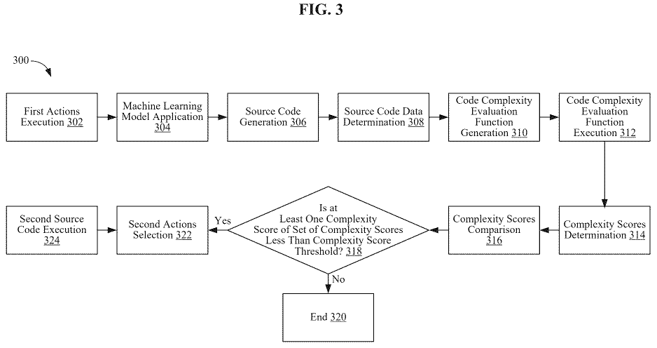

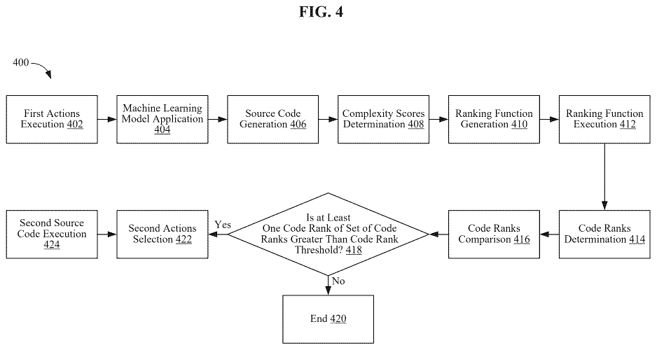

In operation, the computer system 202 is configured to execute the first set of actions 216A of the set of actions 216 to achieve the objective associated with the planning problem. In an example, the computer system 202 corresponds to a flight automation system, the planning problem corresponds to a flight automation problem associated with the flight automation system, the objective associated with the planning problem corresponds to reaching a destination of the flight automation system, and the computer system 202 is configured to execute a first set of control instructions to control one or more components (such as propellers, jet engines, and the like) of the flight automation system. In an additional example, the computer system 202 corresponds to a data security automation system, the planning problem corresponds to a data security problem associated with the data security automation system, and the objective associated with the planning problem corresponds to providing data security for a database, and the computer system 202 is configured to execute a first set of compliance policies on data associated with the database. Details about the execution of the first set of actions 216A are provided, for example, in FIG. 3 and FIG. 4.

The computer system 202 is configured to apply the machine learning model 212 on each action of the set of actions 216. In an embodiment of the disclosure, the computer system 202 is configured to apply the machine learning model 212 to generate the set of source codes 218. Details about the application of the machine learning model 212 are provided, for example, in FIG. 3 and FIG. 4. The utilization of the machine learning model 212 allows the computer system to generate the set of source codes 218 from prompt data associated with the planning problem. The prompt data includes the objective associated with the planning problem, a description associated with the set of source codes 218, and the like. Additionally, the utilization of the machine learning model 212 allows the computer system 202 to reduce the need for manual coding and human errors.

The computer system 202 is configured to generate the set of source codes 218 corresponding to each action of the set of actions 216 based on the application of the machine learning model 212 on each action of the set of actions 216. In an example, the set of source codes 218 corresponds to a set of a programming language codes (such as Python scripts) corresponding to each action of the set of actions 216. In an additional example, the set of source codes 218 corresponds to a set of markup language codes (such as Ansible scripts) corresponding to each action of the set of actions 216. Moreover, the generation of the set of source codes 218 allows the computer system 202 to mitigate the need for the iterative execution of the set of actions 216 to determine a correct sequence of the set of actions 216 with respect to the objective associated with the planning problem, thereby reducing wastage of computational resources associated with the computer system 202. Details about the generation of the set of source codes 218 are provided, for example, in FIG. 3 and FIG. 4.

The computer system 202 is further configured to determine the set of complexity scores 220 based on each source code of the set of source codes 218. Each complexity score of the set of complexity scores 220 is indicative of a computational complexity of a corresponding source code of the set of source codes 218. The determination of the set of complexity scores 220 allows the computer system 202 to determine a consumption of the computational resources associated with the computer system 202 based on the corresponding execution of the set of actions 216. In an example, the set of complexity scores 220 includes a first complexity score (9) associated with a first source code of the set of source codes 218 and a second complexity score (8) associated with a second source code of the set of source codes 218. Further, the computer system 202 is configured to determine that a first consumption of the computational resources based on the execution of the first source code is greater than a second consumption of the computational resources. Details about the determination of the set of complexity scores 220 are provided, for example, in FIG. 3 and FIG. 4.

The computer system 202 is further configured to apply criteria on the set of complexity scores 220. The criteria are associated with a likelihood of execution of the set of actions 216 subsequent to the first set of actions 216A. In an embodiment of the disclosure, the computer system 202 is configured to compare each complexity score of the set of complexity scores 220 with the complexity score threshold. The computer system 202 is configured to determine that the at least one complexity score (such as 9) of the set of complexity scores 220 is less than the complexity score threshold (such as 10) based on the comparison of each complexity score of the set of complexity scores with the complexity score threshold. The determination of the at least one complexity score allows the computer system 202 to determine a source code corresponding to the at least one complexity score. The determination of the source code corresponding to the at least one complexity score mitigates the challenges associated with the iterative execution of the set of actions 216 to decrease an error value between a final state associated with the planning problem and a goal state associated with the planning problem. Details about the application of the criteria are provided, for example, in FIG. 3 and FIG. 4.

The computer system 202 is configured to select the second set of actions 216B from the set of actions 216 based on the application of the criteria on the set of complexity scores 220. The selection of the second set of actions 216B based on the application of the criteria on the set of complexity scores 220 allows the computer system 202 to select the second set of actions 216B to be executed subsequent to the first set of actions 216A, thereby reducing the wastage of the computer system 202 for the determination of a correct sequence of the set of actions 216 with respect to the objective associated with the planning problem. Details about the selection of the second set of actions 216B are provided, for example, in FIG. 3 and FIG. 4.

The computer system 202 is further configured to execute the source code of the set of source codes 218 to execute the set of tasks 214 associated with the planning problem. The source code is associated with the selected second set of actions 216B. Details about the execution of the source code of the set of source codes 218 are provided, for example, in FIG. 3 and FIG. 4.

In an alternate embodiment of the disclosure, the computer system 202 is configured to execute the first set of actions 216A of the set of actions 216 to achieve the objective associated with the planning problem. The computer system 202 is configured to apply the machine learning model 212 on each action of the set of actions 216. Details about the application of the machine learning model 212 are provided, for example, in FIG. 3 and FIG. 4. The computer system 202 is configured to generate the set of source codes 218 corresponding to each action of the set of actions 216 based on the application of the machine learning model 212 on each action of the set of actions 216. Details about the generation of the set of source codes 218 are provided, for example, in FIG. 3 and FIG. 4. The computer system 202 is configured to determine the set of complexity scores 220 based on each source code of the set of source codes 218. Each complexity score of the set of complexity scores 220 is indicative of the computational complexity of the corresponding source code of the set of source codes 218. Details about the determination of the set of complexity scores 220 are provided, for example, in FIG. 3 and FIG. 4. The computer system 202 is configured to determine the set of code ranks 222 based on the set of complexity scores 220. The set of code ranks 222 is indicative of an order of the computational complexity associated with the corresponding source code of the set of source codes 218. Details about the determination of the set of code ranks 222 are provided, for example, in FIG. 3 and FIG. 4. The computer system 202 is configured to apply criteria on the set of code ranks 222. The criteria are associated with the likelihood of execution of the second set of actions 216B of the set of actions 216 subsequent to the first set of actions 216A. Details about the application of the criteria of the set of code ranks 222 are provided, for example, in FIG. 3 and FIG. 4. The computer system 202 is configured to select the second set of actions 216B from the set of actions 216 based on the application of the criteria on the set of code ranks 222. Details about the selection of the second set of actions 216B are provided, for example, in FIG. 3 and FIG. 4. The computer system 202 is configured to execute a source code of the set of source codes 218 to execute the set of tasks 214 associated with the planning problem. The source code is associated with the selected second set of actions 216B. Details about the execution of the source code of the set of source codes 218 are provided, for example, in FIG. 3 and FIG. 4.

FIG. 3 is a diagram that illustrates first exemplary operations for selection of actions associated with a planning problem of an automation system, in accordance with an embodiment of the disclosure. FIG. 3 is explained in conjunction with elements from FIG. 1, and FIG. 2. With reference to FIG. 3, there is shown a block diagram 300 that illustrates exemplary operations from 302 to 324, as described herein. The exemplary operations illustrated in the block diagram 300 may start at 302 and may be performed by any computing system, apparatus, or device, such as by the computer 102 of FIG. 1 or the computer system 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302, a first actions execution operation is executed. In the first actions execution operation, the computer system 202 is configured to execute the first set of actions 216A of the set of actions 216 to achieve the objective associated with the planning problem. In an embodiment of the disclosure, the computer system 202 is configured to determine the first set of actions 216A based on a set of rules associated with the planning problem. The set of rules is associated with a determination of the first set of actions 216A at a first time period. In an example, the set of rules is indicative of the set of actions 216A that is to be executed for the objective associated with the planning problem at the first time period. In various embodiments of the disclosure, the computer system 202 is configured to determine the first set of actions 216A based on historical data associated with the planning problem, The historical data includes a historical set of actions associated with the planning problem, a historical set of timestamps associated with execution of the historical set of actions. The computer system 202 is configured to determine a first historical set of actions from the historical set of actions based on the first time period. The computer system 202 is configured to determine the first set of actions 216A corresponding to the historical set of actions. in an embodiment of the disclosure, the computer system 202 is configured to retrieve the first set of actions 216A from the first set of databases 208 based on the determination of the first set of actions 216A. The computer system 202 is further configured to execute the first set of actions 216A based on the retrieval of the first set of actions 216A.

In an alternative embodiment of the disclosure, the computer system 202 is configured to receive the executed first set of actions 216 from the first set of databases 208. In an example, the computer system 202 corresponds to the flight automation system, the planning problem corresponds to the flight automation problem associated with the flight automation system, the objective associated with the planning problem corresponds to reaching the destination of the flight automation system, and the computer system 202 is configured to execute the first set of control instructions to control the one or more components (such as propellers, jet engines, and the like) of the flight automation system. In an additional example, the computer system 202 corresponds to the data security automation system, the planning problem corresponds to a data security problem associated with the data security automation system, and the objective associated with the planning problem corresponds to providing data security for the database, and the computer system 202 is configured to execute the first set of compliance policies on the data associated with the database.

At 304, a machine learning model application operation is executed. In the machine learning model application operation, the computer system 202 is configured to apply the machine learning model 212 on each action of the set of actions 216. In an embodiment of the disclosure, the computer system 202 is configured to apply the machine learning model 212 to generate the set of source codes 218 corresponding to each action of the set of actions 216.

At 306, a source code generation operation is executed. In the source code generation operation, the computer system 202 is configured to generate the set of source codes 218 corresponding to each action of the set of actions 216 based on the application of the machine learning model 212 on each action of the set of actions 216. In an example, a first prompt data associated with the first source code corresponds to “Given new rule with “rule_id rule_ssh_max_startup_configured” and description “SSH is configured with Max Startup” and the first source code corresponds to
name: Compliance Assessment Workflow for rule_ssh_max_startup_configured
hosts: localhost
tasks: Get validation tool for rule “rule_ssh_max_startup_configured”
   name: Get validation tool for rule “rule_ssh_max_startup_configured” polaris.apg.get_validation_tools_for_rule:
      rule_id: “rule_ssh_max_startup_configured”
   register: validation_tool result
   name: Fail if validation tool is not Ansible fail:
      msg: “Validation tool is not Ansible, cannot proceed.”
   when: validation_tool_result.data!=“Ansible”
   name: Generate Ansible Playbook for SSH Max Startup configuration
   polaris.apg.generate_ansible_playbook:
      prompt: “Create a playbook to check SSH Max Startup configuration
   register: generated_playbook_result

At 308, a source code data determination operation is executed. In the source code data determination operation, the computer system 202 is configured to determine source code data associated with each source code of the set of source codes 218. In an embodiment of the disclosure, the computer system 202 is configured to determine the source code data based on the generation of each source code of the set of source codes 218. The source code data includes an identifier of each source code of the set of source codes, a number of code lines of each source code of the set of source codes, a count of code blocks of each source code of the set of source codes, a count of conditional blocks of each source code of the set of source codes, an amount of memory for execution of each source code of the set of source codes, or a time period for the execution of each source code of the set of source codes. In an example, a first identifier of the first source code is 0001, a number of code lines of the first source code is 150, a count of code blocks of the first source code is 20, a count of conditional blocks of the first source code is 10, an amount of memory for execution of the first source code is 25 megabytes, or a time period for the execution of the first source code is 5 minutes.

At 310, a code complexity evaluation function generation operation is executed. In the code complexity evaluation function generation operation, the computer system 202 is configured to generate a code complexity evaluation function based on a set of complexity factors associated with the source code data. The set of complexity factors includes at least one of a normalization factor (such as 0.1, 0.5, and the like) associated with the number of code lines of each source code of the set of source codes 218, a normalization factor (such as 0.1, 0.5, and the like) associated with the count of code blocks of each source code of the set of source codes 218, a normalization factor (such as 0.1, 0.5, and the like) associated with the count of conditional blocks of each source code of the set of source codes 218, a normalization factor (such as 0.1, 0.5, and the like) associated with the amount of memory for the execution of each source code of the set of source codes 218, and a normalization factor (such as 0.1, 0.5, and the like) associated with the set of total time periods for the execution of each source code of the set of source codes 218.

At 312, a code complexity evaluation function execution operation is executed. In the code complexity evaluation function execution operation, the computer system 202 is configured to execute the code complexity evaluation function based on the source code data. In an embodiment of the disclosure, the computer system 202 is configured to execute the code complexity function to determine the set of complexity scores 220. Each complexity score of the set of complexity scores is indicative of the computational complexity of the corresponding source code of the set of source codes.

At 314, a complexity scores determination operation is executed. In the complexity scores determination operation, the computer system 202 is configured to determine the set of complexity scores 220 based on the execution of the code complexity evaluation function. In an example, the first source code includes an identifier (#0001) of the first source code, a number (50) of code lines of the first source code, a count (20) of code blocks of the first source code, a count (5) of conditional blocks of first source code, an amount (20 megabytes) of memory for execution of the first source code, or a time period (2 minutes) for the execution of the first source code. Further, the computer system 202 is configured to execute the code complexity evaluation function (0.1λ 50+0.1×20+0.1×5+0.1×20+0.1×2) based on the first source code data. The computer system 202 is configured to determine a first complexity score (9) based on the execution of the code complexity evaluation function (0.1×50+0.1× 20+0.1× 5+0.1× 20+0.1×2). Similarly, the computer system 202 is configured to determine a respective complexity score for each source code of the set of source codes 218. In an embodiment of the disclosure, the computer system 202 is configured to determine the set of complexity scores 220 to apply the criteria on the set of complexity scores 220. The criteria are associated with the likelihood of the execution of the second set of actions 216B of the set of actions 216 subsequent to the first set of actions 216A. Details about the application of the criteria on the set of complexity scores 220 are provided below for example, at 316, 318, and 320.

At 316, a complexity scores comparison operation is executed. In the complexity scores comparison operation, the computer system 202 is configured to compare each complexity score of the set of complexity scores 220 with a complexity score threshold. In an example, the computer system 202 is configured to compare the first complexity score (9) with a complexity score threshold (10). In an embodiment of the disclosure, the computer system 202 is configured to determine the complexity score threshold based on a user input. In an example, the computer system 202 is configured to compare the first complexity score (9) with a complexity score threshold (10). Further, the computer system 202 is configured to determine that the first complexity score (9) is less than the complexity score threshold (10) based on the comparison of the first complexity score (9) with the complexity score threshold (10).

At 318, a determination is made whether the at least one complexity score of the set of complexity scores 220 is less than a complexity score threshold. In an embodiment of the disclosure, the computer system 202 is configured to determine whether the at least one complexity score of the set of complexity scores 220 is less than the complexity score threshold. In an embodiment of disclosure, the operations of the method end at 320 based on a determination that the at least one complexity score of the set of complexity scores 220 is greater than the complexity score threshold. Otherwise, the operations of the method proceed to 322 based on a determination that the at least one complexity score of the set of complexity scores 220 is less than the complexity score threshold.

At 322, a second actions selection operation is executed. In the second actions selection operation, the computer system 202 is configured to select the second set of actions 216B based on the application of the criteria on the set of complexity scores 220. In an embodiment of the disclosure, the computer system 202 is configured to select the second set of actions 216B associated with the source code of the at least one complexity score based on the determination that the at least one complexity score of the set of complexity scores 220 is less than the complexity score threshold. In various embodiments of the disclosure, the computer system 202 is configured to determine a subset of complexity scores based on each complexity score of the set of complexity scores 220 that is less than the complexity score threshold. Further, the computer system 202 is configured to determine that a complexity score is lowest within the subset of complexity scores based on the determination of the subset of complexity scores. The computer system 202 is configured to select the second set of actions 216B associated with a source code of the determined complexity score based on the determination that the complexity score is lowest within the subset of complexity scores.

In an alternative embodiment of the disclosure, the computer system 202 is configured to determine that a complexity score is lowest within the set of complexity scores 220. Further, the computer system 202 is configured to select the second set of actions 216B associated with a source code of the complexity score that is lowest within the set of complexity scores 220. The selection of the second set of actions 216B based on the application of the criteria on the set of complexity scores 220 allows the computer system 202 to select the second set of actions 216B to be executed subsequent to the first set of actions 216A, thereby reducing the wastage of the computational resources associated with the computer system 202 for the determination of a correct sequence of the set of actions 216 with respect to the objective associated with the planning problem.

At 324, a second source code execution operation is executed. In the second source code execution operation, the computer system 202 is configured to execute the source code of the set of source codes 218. The source code is associated with the selected second set of actions 216B. In an example, the computer system 202 is configured to execute a second set of control instructions subsequent to the first set of control instructions. The second set of control instructions is executed to control the one or more components (such as propellers, jet engines, and the like) of the flight automation system. In an additional example, the computer system 202 is configured to execute a second set of compliance policies subsequent to the first set of compliance policies. The second set of compliance policies is executed on the data associated with the database.

FIG. 4 is a diagram that illustrates second exemplary operations for selection of actions associated with a planning problem of an automation system, in accordance with an embodiment of the disclosure. FIG. 4 is explained in conjunction with elements from FIG. 1, FIG. 2, and FIG. 3. With reference to FIG. 3, there is shown a block diagram 300 that illustrates exemplary operations from 402 to 324, as described herein. The exemplary operations illustrated in the block diagram 400 may start at 402 and may be performed by any computing system, apparatus, or device, such as by the computer 102 of FIG. 1 or the computer system 202 of FIG. 2. Although illustrated with discrete blocks, the exemplary operations associated with one or more blocks of the block diagram 400 may be divided into additional blocks, combined into fewer blocks, or eliminated, depending on the particular implementation.

At 402, a first actions execution operation is executed. In the first actions execution operation, the computer system 202 is configured to execute the first set of actions 216A of the set of actions 216 to achieve the objective associated with the planning problem. Details about the execution of the first set of actions 216A are provided, for example, in FIG. 3.

At 404, a machine learning model application operation is executed. In the machine learning model application operation, the computer system 202 is configured to apply the machine learning model 212 on each action of the set of actions 216. Details about the application of the machine learning model 212 are provided, for example, in FIG. 3.

At 406, a source code generation operation is executed. In the source code generation operation, the computer system 202 is configured to generate the set of source codes 218 corresponding to each action of the set of actions 216 based on the application of the machine learning model 212 on each action of the set of actions 216. Details about the generation of the set of source codes 218 are provided, for example, in FIG. 3.

At 408, a complexity scores determination operation is executed. In the complexity scores determination operation, the computer system 202 is configured to the set of complexity scores 220 based on the execution of the code complexity evaluation function. Each complexity score of the set of complexity scores is indicative of the computational complexity of the corresponding source code of the set of source codes. Details about the determination of the set of complexity scores 220 are provided, for example, in FIG. 3.

At 410, a ranking function generation operation is executed. In the ranking function generation, the computer system 202 is configured to generate a ranking function based on a scaling factor associated with the set of complexity scores 220. The scaling factor corresponds to one of a normalization factor associated with a normalization of the set of complexity scores 220, a normalization factor associated with a mean of the set of complexity scores 220, a normalization factor associated with a standard deviation of the set of complexity scores 220, or a normalization factor associated with a log of the set of complexity scores 220. The normalization factor associated with the normalization of the set of complexity scores 220 is defined as:

$$( {X}_{norm} = \frac{X - {X}_{min}}{{X}_{max} - {X}_{min}} ) \qquad ( 1 )$$

where, X is a complexity score of the set of complexity scores 220, Xₘᵢₙ is a minimum complexity score within the set of complexity scores 220, and Xₘₐₓ is a maximum complexity score within the set of complexity scores 220.

The normalization factor associated with the mean (denoted by u) of the set of complexity scores 220 is defined as:

$$μ = \frac{\sum each complexity score of the set of coplexity scores 220 )}{N} \qquad ( 2 )$$

where, N is a count of complexity scores within the set of complexity scores 220.

The normalization factor associated with the standard deviation

$$( {X}_{standard} = \frac{X - μ}{σ} )$$

of the set of complexity scores 220 is defined as:

$${X}_{standard} = \frac{X - μ}{\sqrt{\frac{1}{N - 1}} {\sum }_{i = 1}^{N} {( {X}_{i} - μ )}^{2}} \qquad ( 3 )$$

where, X is the complexity score of the set of complexity scores 220, μ is the mean of the set of complexity scores 220, and N is the count of complexity scores within the set of complexity scores 220.

The normalization factor associated with the log (denoted by X_{log}) of the set of complexity scores 220 is defined as:

X_{log}=log(X+1) (4)
where,
X is the complexity score of the set of complexity scores 220.

At 412, a ranking function execution operation is executed. In the ranking function execution operation, the computer system 202 is configured to execute the ranking function based on the set of complexity scores 220. In an embodiment of the disclosure, the computer system 202 is configured to execute the ranking function to determine the set of code ranks 222. The set of code ranks 222 is indicative of the order of the computational complexity associated with the corresponding source code of the set of source codes 218.

At 414, a code ranks determination operation is executed. In the code ranks determination operation, the computer system 202 is configured to determine the set of code ranks 222 based on the execution of the ranking function. In an example, the set of code ranks 222 includes a first code rank (9), a second code rank (10), and a third code rank (11). The execution of the ranking function based on the set of complexity scores 220 is provided in the Table 1 below:

TABLE 1

| Serial Number | Ranking Function | Set of Code |
|---|---|---|
| (S. No.) | f (x) | Rank Values |
| 1 | Xₙₒᵣₘ | 0.0, 0.5, 1.0 |
| 2 | X · μ | 90, 100, 110 |
| 3 | X_{standard} | −1.2247, 0.0000, 1.2247 |
| 4 | X_{log} | 1, 1.04, 1.07 |

In an embodiment of the disclosure, the computer system 202 is configured to map each code rank value of the set of code rank values with a set of rank output values (such as 1, 2, and 3). Specifically, the computer system 202 is configured to map each code rank value of the set of code rank values within a range associated with the set of code rank values. Further, the computer system 202 is configured to determine the set of code ranks 222 based on the mapping of each code rank value of the set of code rank values within the range associated with the set of code rank values. In an example, referring back to Table 1 at S. No. (1), a first code rank value is 0.0, a second code rank value is 0.5, a third code rank value is 1.0, and the computer system 202 is configured to map the first code rank value (0.0) with a first rank output value (1) based on a mapping of the first code rank value (0.0) with a first range (0.0-0.4). The computer system 202 is configured to map the second code rank value (0.5) with a second rank output value (2) based on a mapping of the second code rank value (0.5) with a second range (0.5-0.8). The computer system 202 is configured to map the third code rank value (1.0) with a third rank output value (3) based on a mapping of the third code rank value (1.0) with a third range (0.9-1.0). Similarly, the computer system 202 is configured to determine the set of code ranks 222 based on each code rank value of the set of code rank values.

At 416, a code ranks comparison operation is executed. In the code ranks determination operation, the computer system 202 is configured to compare each code rank of the set of code ranks 222 with a code rank threshold. In an example, the computer system 202 is configured to compare the first code rank (1) with a code score threshold (2). In an embodiment of the disclosure, the computer system 202 is configured to determine the code rank threshold based on a user input. Further, the computer system 202 is configured to determine that the first code rank (1) is greater than the code rank threshold (2) based on the comparison of the first code rank (1) with the code rank threshold (2).

At 418, a determination is made whether that at least one code rank of the set of code ranks 222 is greater than the code rank threshold or not. In an embodiment of the disclosure, the computer system 202 is configured to whether that at least one code rank of the set of code ranks 222 is greater than the code rank threshold or not based on the comparison of each code rank of the set of code ranks with the code rank threshold. In an embodiment of disclosure, the operations of the method end at 420 based on a determination that the at least one code rank of the set of code ranks 222 is less than the code rank threshold. Otherwise, the operations of the method proceed to 422 based on a determination that the at least one code rank of the set of code ranks 222 is greater than the code rank threshold.

At 422, a second actions selection operation is executed. In the second actions selection operation, the computer system 202 is configured to select the second set of actions 216B from the set of actions 216 based on the application of the criteria on the set of code ranks 222. In an embodiment of the disclosure, the computer system 202 is configured to select the second set of actions 216B associated with the at least one code rank based on the determination that the at least one code rank of the set of code ranks 222 is greater than the code rank threshold.

In various embodiments of the disclosure, the computer system 202 is configured to determine a subset of code ranks based on each code rank of the set of code ranks 222 that is greater than the code rank threshold. Further, the computer system 202 is configured to determine that a code rank is highest within the subset of code ranks based on the determination of the subset of code ranks. The computer system 202 is configured to select the second set of actions 216B associated with a source code of the determined code rank based on the determination that the code rank is highest within the subset of code ranks. In an alternative embodiment of the disclosure, the computer system 202 is configured to determine that a code rank is highest within the set of code ranks 222. Further, the computer system 202 is configured to select the second set of actions 216B associated with a source code of the code rank that is highest within the set of code ranks 222. The SOUS selection of the second set of actions 216B based on the application of the criteria on the set of code ranks 222 allows the computer system 202 to select the second set of actions 216B to be executed subsequent to the first set of actions 216A, thereby reducing the wastage of the computational resources associated with the computer system 202 for the determination of a correct sequence of the set of actions 216 with respect to the objective associated with the planning problem.

At 424, a second source code execution operation is executed. In the second source code execution operation, the computer system 202 is configured to execute a source code of the set of source codes 218 to execute the set of tasks 214 associated with the planning problem. The source code is associated with the selected second set of actions 216B. Details about the execution of the second source code are provided, for example, in FIG. 3.

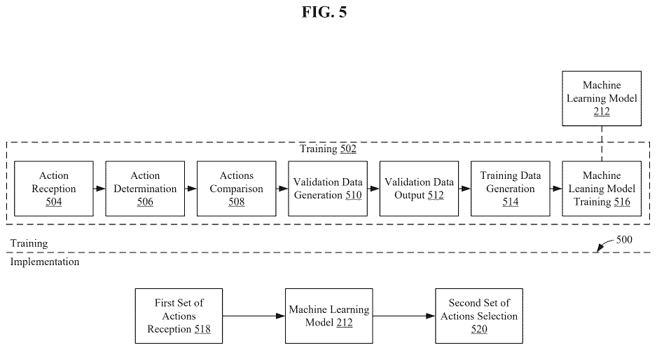

FIG. 5 is a diagram that illustrates training 502 of the machine learning model 212 for selection of actions associated with a planning problem of an automation system, in accordance with an embodiment of the disclosure. As shown, there is a training portion above line 500 and an implementation portion below line 500.

In the training portion above line 500, at 504, an action reception operation is executed. In the action reception operation, the computer system 202 is configured to receive at least one action of the set of actions 216 for the training 502 of the machine learning model 212. The at least one action of the set of actions 216 is executed subsequent to the first set of actions 216A. In the action reception operation, the computer system 202 is configured to receive the at least one action of the set of actions 216 from the first set of databases 208.

At 506, an action determination operation is executed. In the action determination operation, the computer system 202 is configured to determine an action of the second set of actions 216B corresponding to a first code rank of the set of code ranks 222. In an embodiment of the disclosure, the first code rank corresponds to a highest code rank within the set of code ranks 222. In an example, the first set of actions 216A includes a first action, a second action, and a third action. Further, the set of code ranks 222 includes a first code rank (1), a second code rank (2), and a third code rank (3) corresponding to the first action, the second action, and the third action, respectively. Thereafter, the computer system 202 is configured to determine the first action of the second set of actions 216B corresponding to the first code rank (1) of the set of code ranks 222 based on a determination that the first code rank is highest within the set of code ranks 222. In an alternate embodiment, the computer system 202 is configured to determine the action of the second set of actions 216B corresponding to the first complexity score (9) of the set of complexity scores 220. In an embodiment of the disclosure, the first complexity score corresponds to a lowest complexity score within the set of complexity scores 220.

At 508, an actions comparison operation is executed. In the actions comparison operation, the computer system 202 is configured to compare the at least one action of the set of actions 216 with the action of the second set of actions 216B. Specifically, the computer system 202 is configured to determine the first code rank of the at least one action of the set of actions 216. Further, the computer system 202 is configured to determine a second code rank of the action of the second set of actions 216B. Thereafter, the computer system 202 is configured to compare the first code rank with the second code rank. Similarly, the computer system 202 is configured to determine the first complexity score of the at least one action of the set of actions 216. Further, the computer system 202 is configured to determine a second complexity score of the action of the second set of actions 216B. Thereafter, the computer system 202 is configured to compare the first complexity score with the second complexity score. Details about the generation of the validation data based on the comparison of the first code rank and the second code rank are provided, at 510.

At 510, a validation data generation operation is executed. In the validation data generation operation, the computer system 202 is configured to generate validation data for the at least one action of the set of actions 216 based on the comparison of the at least one action of the set of actions 216 with the action of the second set of actions 216B. The validation data is associated with at least a classification of an accuracy of the at least one action associated with the objective. In an example, the validation data is provided in the Table 2 below:

TABLE 2
Validation Data

| | | Code Rank of | The Action of | |
|---|---|---|---|---|
| Serial | At Least One | At Least One | the Second Set | |
| Number | Action of the | Action of the | of Actions with | |
| (S. No.) | Set of Actions | Set of Actions | Code Rank (1) | Accuracy |
| 1 | First Action | 1 | First Action | Best |
| 2 | Second Action | 2 | First Action | Moderate |
| 3 | Third Action | 3 | First Action | Worst |

Referring back to Table 2 at S. No. (1), the computer system 202 is configured to determine a first difference (0) between a code rank (1) of the first action of the at least one action with a code rank (1) of the action of the second set of actions 216B. Further, the computer system 202 is configured to classify the accuracy of the at least one action based on the first difference. In an embodiment of the disclosure, the computer system 202 is configured to classify a first accuracy of the first action of the at least one action based on a mapping of the first difference with a set of accuracy values (such as “Best”, “Moderate”, and “Worst”). In an example, the computer system 202 is configured to map the first difference (0) with the “Best”.

Referring back to Table 2 at S. No. (2), the computer system 202 is configured to determine a second difference (1) between a code rank (2) of the at least one action with the code rank (1) of the action of the second set of actions 216B. Further, the computer system 202 is configured to classify a second accuracy of the second action as “Moderate” based on the second difference (1). Referring back to table 2 at S. No. (3), the computer system 202 is configured to a third difference between a code rank (3) of the at least one action with the code rank (1) of the action of the second set of actions 216B. Further, the computer system 202 is configured to classify a third accuracy of the third action as “Worst” based on the difference (2).

At 512, a validation data output operation is executed. In the validation data output operation, the computer system 202 is configured to output the validation data. In the validation data output operation, the computer system 202 is configured to output the validation data based on the generation of the training data. In an embodiment of the disclosure, the computer system 202 is configured to output the validation data on a user interface associated with the computer system 202. In various embodiments of the disclosure, the computer system 202 is configured to provide the validation data, as an input, to the machine learning model 212.

At 514, a training data generation operation is executed. In the training data generation operation, the computer system 202 is configured to generate training data for the machine learning model 212. In an embodiment of the disclosure, the computer system 202 is configured to apply a set of processing techniques to the validation data. Further, the computer system 202 is configured to generate the training data based on the application of the set of processing techniques on the validation data. The set of processing techniques includes, but is not limited to, a set of data cleaning techniques (such as a removal of at least one portion of the validation data), a set of normalization techniques (such as a scaling of the validation data), a set of augmentation techniques (such as a rotation of the validation data), and the like).

At 516, a machine learning model training operation is executed. In the machine learning training operation, the computer system 202 is configured to train the machine learning model 212 based on the generated training dataset. In an embodiment, the computer system 202 is configured to provide the machine learning model 212 with the training data. The machine learning model 212 is configured to determine a machine learning ML algorithm for the selection of the second set of actions 216B from the set of actions 216.

In an embodiment, the computer system 202 is further configured to adjust the weights and the hyperparameters of the machine learning model 212 based on a determination that a predicted output value (such as the second action of the set of actions 216) is not equal (or does not match) the actual output value (such as the first action of the set of actions 216) in the set of output values. In an embodiment, the computer system 202 is further configured to repeat the adjustment of the weights and the hyperparameters until the predicted output matches the actual output for various input-output pairs in the training dataset, or until the minima of the loss function is achieved or the training error is minimized.

In the implementation portion below line 500, at 518, a first actions reception operation is executed. In the first actions reception operation, the computer system 202 is configured to receive the first set of actions 216A of the set of actions 216. The first set of actions 216A is to achieve the objective associated with the planning problem. In an embodiment of the disclosure, the computer system 202 is configured to receive the executed first set of actions 216A from the first set of databases 208.

At 520, a second set of actions selection operation is executed. In the second set of actions selection operation, the computer system 202 is configured to apply the machine learning model 212 on the first set of actions 216A. Further, the computer system 202 is configured to select the second set of actions 216B from the set of actions 216 based on the application of the machine learning model 212 on the first set of actions 216A.

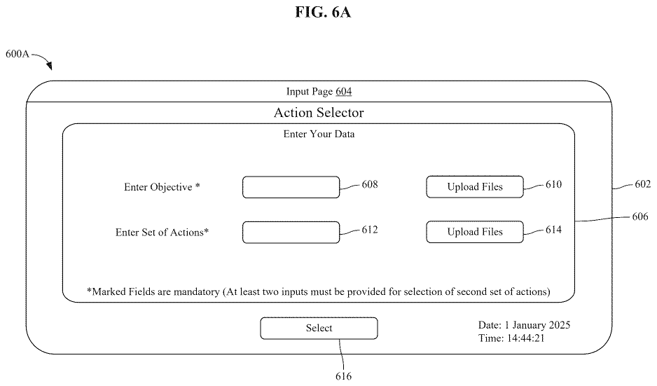

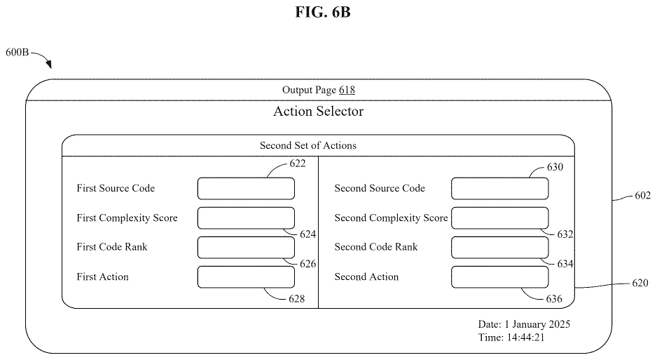

FIG. 6A is a diagram that illustrates an exemplary first user interface for selection of actions associated with a planning problem of an automation system, in accordance with an embodiment of the disclosure. FIG. 6A is explained in conjunction with elements from FIG. 1, FIG. 2, FIG. 3, FIG. 4, and FIG. 5. With reference to FIG. 6A, there is shown an exemplary diagram 600A that includes a user device 602 and an exemplary input page 604. The exemplary input page 604 includes a first user interface (UI) element 606, a second UI element 608, a third UI element 610, a fourth UI element 612, a fifth UI element 614, and a sixth UI element 616. The user device 602 is an example embodiment of the first user device 204 of FIG. 2.

With reference to FIG. 6A, the computer system 202 is configured to receive one or more inputs from the user device 602. The user device 602 includes the display screen 206 that renders the exemplary input page 604 on the user device 602 to be seen by the user 224. In an embodiment, the exemplary input page 604 corresponds to a web page or an online form that is designed to collect information from the user 224 who wishes to select the second set of actions 216B to be executed subsequent to the first set of actions 216A. In an embodiment of the disclosure, the exemplary input page 604 is used to gather relevant data from the user to select the second set of actions 216B from the set of actions 216.

The first UI element 606 corresponds to a textbox that includes a message for the user, for example, “Enter Your Data”. The first UI element 606 further includes the second UI element 608, the third UI element 610, the fourth UI element 612, and the fifth UI element 614. The second UI element 608 corresponds to a textbox labeled as “Enter Objective”. The second UI element 608 is configured to receive the objective associated with the planning problem. In an embodiment of the disclosure, the second UI element 608 is a mandatory input parameter that needs to be provided for the selection of the second set of actions 216B. The third UI element 610 corresponds to a button and is labeled as “Upload Files”. In an alternative embodiment of the disclosure, upon selecting the third UI element 610, the computer system 202 is configured to receive the objective associated with the planning problem. In an example, the objective associated with the planning problem corresponds to “you are a compliance assessment agent for performing compliance assessment, who is an expert on regulatory controls, security check programs by Ansible Playbook, and GRC (Governance, Risk, Compliance) tools. The compliance assessor routinely understands compliance requirements, writes Ansible Playbook to fetch and check the status from target systems, deploys the playbook to Ansible Automation Platform, and gathers playbook job results via Compliance-to-Policy (C2P). You do the same as what the compliance assessor does routinely. For taking an action, you can use Ansible Playbook. In the playbook, you can leverage the following modules.”

The fourth UI element 612 corresponds to a textbox labeled as “Enter First Set of Actions”. The fourth UI element 612 is configured to receive the first set of actions 216A. In an embodiment of the disclosure, the fourth UI element 612 is a mandatory input parameter that needs to be provided for the selection of the first set of actions 216A. The fifth UI element 614 corresponds to a button and is labeled as “Upload Files”. In an alternative embodiment of the disclosure, upon selecting the fifth UI element 614, the computer system 202 is configured to receive the first set of actions 216A. In an example, the first set of actions 216A corresponds to:
1. You can use a module polaris. apg. get_validation_tools_for_rule defined below for getting the validation tool
used for a rule_id. See an example below.
   name: Getting the validation tool
polaris. apg. get_validation_tools for rule:
rule_id: rule_id
register: name_of_validation_tool
where the registered value name_of_validation_tool is the name of validation tool, which should be Ansible or
Auditree.
2. You can use a module polaris.apg.get_similar_ansible_playbooks defined below for getting Ansible Playbooks
semantically similar to the provided description desc.
name: Getting Similar Playbook
polaris.apg.get_similar_ansible_playbooks:
text: desc
register: similar_playbook
where
text parameter of this module specifies description which is used to identify a similar playbook. the registered value similar playbook is a playbook semantically similar to the provided description desc.
3. You can use a module polaris. apg. generate_ansible playbook defined below for Ansible Playbook from the provided prompt text.
def generate_ansible_playbook (text: str, example: str)->str:
   name: Generate Ansible Playbook
polaris.apg. generate_ansible_playbook:
text: mytext
example; myexample
register: generated_playbook
where, text parameter of this module specifies text which explains playbook to be generated.
example parameter of this module specifies an example playbook semantically similar to the mytext
the registered value generated_playbook is a playbook generated.

The sixth UI element 616 corresponds to a button and is labeled as “Select”. Upon selecting the sixth UI element 616, the computer system 202 is configured to render an exemplary output page 618 for the selection of the second set of actions 216B.

FIG. 6B is a diagram that illustrates an exemplary second user interface for selection of actions associated with a planning problem of an automation system, in accordance with an embodiment of the disclosure. FIG. 6B is explained in conjunction with elements from FIG. 1, FIG. 2, FIG. 3, FIG. 4, FIG. 5, and FIG. 6A. With reference to FIG. 6B, there is shown an exemplary diagram 600B that includes the user device 602 and the exemplary output page 618. The exemplary output page 618 includes a seventh UI element 620, an eighth UI element 622, a ninth UI element 624, a tenth UI element 626, an eleventh UI element 628, a twelfth UI element 630, a thirteenth UI element 632, a fourteenth UI element 634, and a fifteenth UI element 636. The user device 602 is an example embodiment of the first user device 204 of FIG. 2.

With reference to FIG. 6B, the computer system 202 is configured to output the second set of actions 216B on the exemplary second user interface. The user device 602 includes the display unit the display screen 206 that renders the exemplary output page 618 to the user 224. The computer system 202 is configured to render the exemplary output page 618 on the user interface (UI) of the user device 602. The exemplary output page 618 corresponds to a web page or online form that is designed to display the second set of actions 216B.

The seventh UI element 620 corresponds to a set of textboxes labeled as “Second Set of Actions”. The seventh UI element 620 includes the eighth UI element 622, the ninth UI element 624, the tenth UI element 626, the eleventh UI element 628, the twelfth UI element 630, the thirteenth UI element 632, the fourteenth UI element 634 and the fifteenth UI element 636.

The eighth UI element 622 corresponds to a textbox labeled as “First Source Code”. The eighth UI element 622 is configured to render the first source code of the set of source codes 218. The first source code is generated corresponding to the first action of the set of actions 216. In an example, the first source code corresponds to:
name: Compliance Assessment Workflow for rule_ssh_max_startup_configured
   hosts: localhost
   tasks:
name: Get validation tool for rule “rule_ssh_max_startup_configured”
   polaris.apg. get_validation_tools for rule:
   rule_id: “rule_ssh_max_startup_configured”
   register: validation_tool_result
name: Fail if validation tool is not Ansible
   fail:
   msg: “Validation tool is not Ansible, cannot proceed.”
   when: validation_tool_result. data!=“Ansible”
-
   name: Generate Ansible Playbook for SSH Max Startup configuration
   polaris.apg.generate_ansible playbook:
   prompt: “Create a playbook to check SSH Max Startup configuration.”
   register: generated_playbook_result

The ninth UI element 624 corresponds to a textbox labeled as “First Complexity Score”. The ninth UI element 624 is configured to render the first complexity score of the set of complexity scores 220. The first complexity score is indicative of the first complexity score of the first source code. The tenth UI element 626 corresponds to a textbox labeled as “First Code Rank”. The tenth UI element 626 is configured to render a first code rank of the set of code ranks 222. The first code rank is indicative of the order of the first computational complexity associated with the first source code. The eleventh UI element 628 corresponds to a textbox labeled as “First Action”. The eleventh UI element 628 is configured to render a selected first action of the second set of actions 216B.

The twelfth UI element 630 corresponds to a textbox labeled as “Second Source Code”. The twelfth UI element 630 is configured to render the second source code of the set of source codes 218. The second source code is generated corresponding to the second action of the set of actions 216. In an example, the second source code corresponds to
name: Check for SSH Max Startup Configuration Compliance and Push Results to SCC hosts: localhost
   tasks:
name: Get validation tool for the rule
   polaris.apg.get_validation_tools for rule:
   rule_id: “rule_ssh_max_startup_configured”
   register: validation_tool_result
name: Fail if validation tool is not defined fail:
   msg: “Error: Validation tool is not defined.”
   when: validation_tool_result. data is undefined
name: Fail if validation tool is not Ansible (check 1)
   fail:
   msg: “Error: Validation tool is not Ansible. Only Ansible is supported.”
   when: validation_tool_result. data!=“Ansible”
name: Fail if validation tool is not Ansible (check 2, for redundancy)
   fail:
   msg: “Error: The validation tool must be Ansible, but received: {{validation
   when: “‘Ansible’ not in validation_tool result.data”
name: Generate Ansible playbook for SSH Max Startup configuration check
   polaris.apg.generate_ansible_playbook:
   prompt: “Write an Ansible Playbook to check if SSH is configured with Max Star
   register: generated_playbook_result

The thirteenth UI element 632 corresponds to a textbox labeled as “Second Complexity Score”. The thirteenth UI element 632 is configured to render the second complexity score of the set of complexity scores 220. The second complexity score is indicative of a second complexity score of the second source code. The fourteenth UI element 634 corresponds to a textbox labeled as “Second Code Rank”. The fourteenth UI element 634 is configured to render a second code rank of the set of code ranks 222. The second code rank is indicative of an order of the second computational complexity associated with the second source code. The fifteenth UI element 636 corresponds to a textbox labeled as “Second Action”. The fifteenth UI element 636 is configured to render a selected second action of the second set of actions 216B.

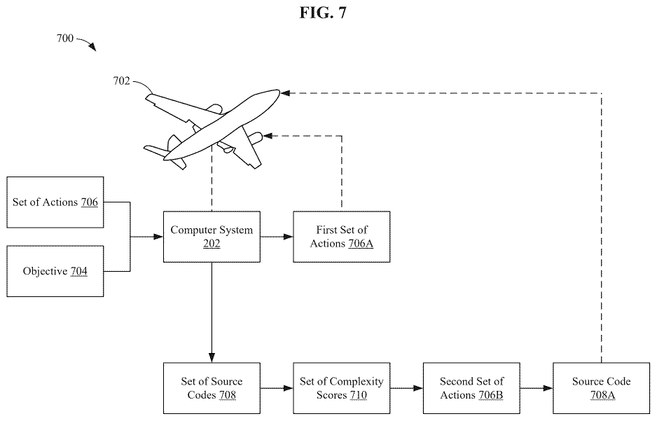

FIG. 7 is a diagram that illustrates a scenario 700 for selection of actions associated with a planning problem of an automation system, in accordance with an embodiment of the disclosure. FIG. 7 is explained in conjunction with elements from FIG. 1, FIG. 2, FIG. 3, FIG. 4 FIG. 5, FIG. 6A and FIG. 6B. With reference to FIG. 7, there is shown an aerial vehicle 702, an objective 704 associated with a planning problem for the aerial vehicle 702, a set of actions 706 to achieve the objective 704 associated with the planning problem for the aerial vehicle 702, a set of source codes 708 corresponding to each action of the set of actions 706, a set of complexity scores 710 and the computer system 202 of FIG. 2.

In an embodiment of the disclosure, the computer system 202 is configured to execute the first set of actions 706A of the set of actions 706 to achieve the objective associated with the planning problem for the aerial vehicle 702. The planning problem for the aerial vehicle 702 corresponds to reaching a destination of the aerial vehicle 702. In an embodiment of the disclosure, the computer system 202 is configured to execute the first set of actions 706A to a first task of a set of tasks associated with the planning problem. In an example, the first task of the set of tasks corresponds to reaching a first intermediate location with respect to the destination of the aerial vehicle 702. The computer system 202 is configured to apply the machine learning model 212 on each action of the set of actions 706. The computer system 202 is configured to generate the set of source codes 708 corresponding to each action of the set of actions 706 based on the application of the machine learning model 212 on each action of the set of actions 706.

The computer system 202 is configured to determine the set of complexity scores 710 based on each source code of the set of source codes 708. Each complexity score of the set of complexity scores 710 is indicative of a computational complexity of the corresponding source code of the set of source codes 708. The computer system 202 is further configured to apply criteria on the set of complexity scores 710. The criteria are associated with a likelihood of execution of a second set of actions 706B of the set of actions 706 subsequent to the first set of actions 706A. The computer system 202 is configured to select the second set of actions 706B from the set of actions 706 based on the application of the criteria on the set of complexity scores 710. The computer system 202 is configured to execute a source code 708A of the set of source codes 708 to execute a second task of the set of tasks. The source code 708A is associated with the selected second set of actions 706B. In an example, the second task corresponds to reaching a second intermediate location with respect to the destination of the aerial vehicle 702. Similarly, the computer system 202 is configured to control the aerial vehicle 702 to reach the destination of the aerial vehicle 702.

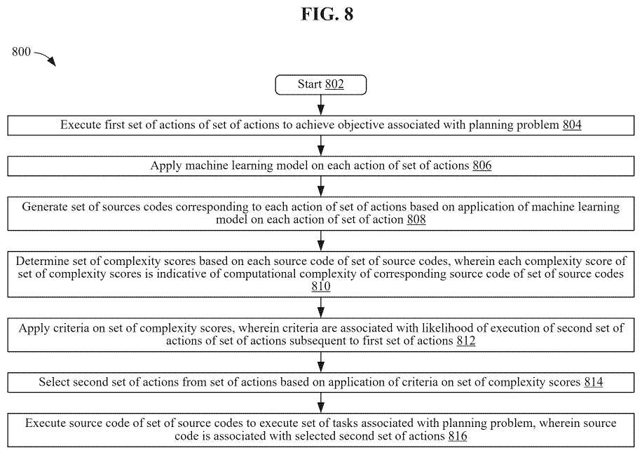

FIG. 8 is a diagram that illustrates a first flowchart 800 of a method for selection of actions associated with a planning problem of an automation system, in accordance with an embodiment of the disclosure. FIG. 8 is explained in conjunction with elements from FIG. 1, FIG. 2, FIG. 3, FIG. 4, FIG. 5, FIG. 6A, FIG. 6B and FIG. 7. The operations of the method illustrated by the first flowchart 800 may be executed by any computing system, for example, by the computer 102 of FIG. 1 or the computer system 202 of FIG. 2. The operations of the first flowchart 800 may start at 802.

At 804, the first set of actions 216A of the set of actions 216 is executed to achieve the objective associated with the planning problem. In an embodiment of the disclosure, the computer system 202 is configured to execute the first set of actions 216A of the set of actions 216 to achieve the objective associated with the planning problem. Details about the execution of the first set of actions 216A are provided, for example, in FIG. 3 and FIG. 4.

At 806, the machine learning model 212 is applied on each action of the set of actions 216. In an embodiment of the disclosure, the computer system 202 is configured to apply the machine learning model 212 on each action of the set of actions 216. Details about the application of the machine learning model 212 are provided, for example, in FIG. 3 and FIG. 4.

At 808, the computer system 202 is configured to generate the set of source codes 218 corresponding to each action of the set of actions 216 based on the application of the machine learning model 212 on each action of the set of actions 216. In an embodiment of the disclosure, the computer system 202 is configured to generate the set of source codes 218 corresponding to each action of the set of actions 216 based on the application of the machine learning model 212 on each action of the set of actions 216. Details about the generation of the set of source codes 218 are provided, for example, in FIG. 3 and FIG. 4.

At 810, the set of complexity scores 220 is determined based on each source code of the set of source codes 218. Each complexity score of the set of complexity scores 220 is indicative of the computational complexity of the corresponding source code of the set of source codes 218. In an embodiment of the disclosure, the computer system 202 is configured to determine the set of complexity scores 220 based on each source code of the set of source codes 218. Details about the determination of the set of complexity scores 220 are provided, for example, in FIG. 3 and FIG. 4.

At 812, the criteria are applied on the set of complexity scores 220. The criteria are associated with the likelihood of the execution of the set of actions 216 subsequent to the first set of actions 216. In an embodiment of the disclosure, the computer system 202 is configured to apply the criteria on the set of complexity scores 220. The criteria are associated with the likelihood of the execution of the second set of actions 216B of the set of actions 216 subsequent to the first set of actions 216. Details about the application of the criteria are provided, for example, in FIG. 3 and FIG. 4.

At 814, the second set of actions 216B is selected from the set of actions 216 based on the application of the criteria on the set of complexity scores 220. In an embodiment of the disclosure, the computer system 202 is configured to select the second set of actions 216B from the set of actions 216 based on the application of the criteria on the set of complexity scores 220. Details about the selection of the second set of actions 216B from the set of actions 216 are provided, for example, in FIG. 3 and FIG. 4.

At 816, a source code of the set of source codes 218 is executed to execute the set of tasks 214 associated with the planning problem. The source code is associated with the selected second set of actions 216B. In an embodiment of the disclosure, the computer system 202 is configured to execute the source code of the set of source codes 218. Details about the execution of the source code of the set of source codes 218 are provided, for example, in FIG. 3 and FIG. 4.

While the above operations shown in FIG. 8 are described in a particular sequence, the operations may occur in variations to the sequence in accordance with various embodiments of the present disclosure. Further, details related to various operations of FIG. 8 which are already covered in the description related to FIG. 1, FIG. 2, FIG. 3, FIG. 4, FIG. 5, FIG. 6A, FIG. 6B, and FIG. 7 are not discussed again in detail here for the sake of brevity.

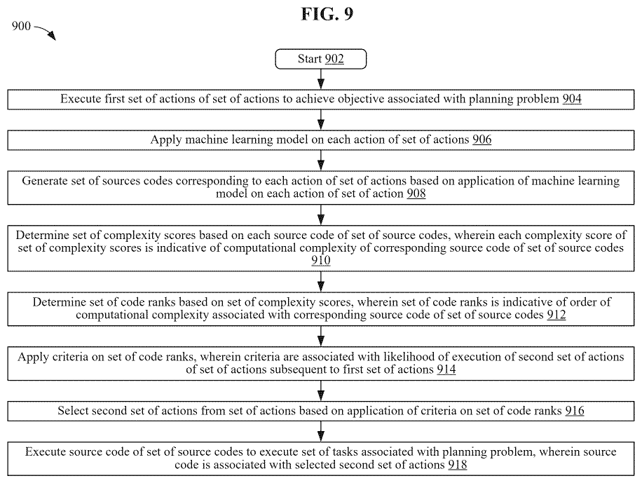

FIG. 9 is a diagram that illustrates a second flowchart 900 of a method for selection of actions associated with a planning problem of an automation system, in accordance with an embodiment of the disclosure. FIG. 9 is explained in conjunction with elements from FIG. 1, FIG. 2, FIG. 3, FIG. 4, FIG. 5, FIG. 6A, FIG. 6B, FIG. 7, and FIG. 8. The operations of the method illustrated by the second flowchart 900 may be executed by any computing system, for example, by the computer 102 of FIG. 1 or the computer system 202 of FIG. 2. The operations of the second flowchart 900 may start at 902.

At 904, the first set of actions 216A of the set of actions 216 is executed to achieve the objective associated with the planning problem. In an embodiment of the disclosure, the computer system 202 is configured to execute the first set of actions 216A of the set of actions 216 to achieve the objective associated with the planning problem. Details about the execution of the first set of actions 216A are provided, for example, in FIG. 3 and FIG. 4.

At 906, the machine learning model 212 is applied on each action of the set of actions 216. In an embodiment of the disclosure, the computer system 202 is configured to apply the machine learning model 212 on each action of the set of actions 216. Details about the application of the machine learning model 212 are provided, for example, in FIG. 3 and FIG. 4.

At 908, the computer system 202 is configured to generate the set of source codes 218 corresponding to each action of the set of actions 216 based on the application of the machine learning model 212 on each action of the set of actions 216. In an embodiment of the disclosure, the computer system 202 is configured to generate the set of source codes 218 corresponding to each action of the set of actions 216 based on the application of the machine learning model 212 on each action of the set of actions 216. Details about the generation of the set of source codes 218 are provided, for example, in FIG. 3 and FIG. 4.

At 910, the set of complexity scores 220 is determined based on each source code of the set of source codes 218. Each complexity score of the set of complexity scores 220 is indicative of the computational complexity of the corresponding source code of the set of source codes 218. In an embodiment of the disclosure, the computer system 202 is configured to determine the set of complexity scores 220 based on each source code of the set of source codes 218. Details about the determination of the set of complexity scores 220 are provided, for example, in FIG. 3 and FIG. 4.

At 912, the set of code ranks is determined based on the set of complexity scores 220. The set of complexity scores 220 is indicative of the order of the computational complexity associated with the corresponding source code of the set of source codes 218. In an embodiment of the disclosure, the computer system 202 is configured to determine the set of code ranks 222 based on the set of complexity scores 220. Details about the determination of the set of code ranks 222 are provided, for example, in FIG. 3 and FIG. 4.

At 914, the criteria are applied on the set of code ranks 222. The criteria are associated with the likelihood of the execution of the second set of actions 216B of the set of actions 216 subsequent to the first set of actions 216. In an embodiment of the disclosure, the computer system 202 is configured to apply the criteria on the set of code ranks 222. Details about the application of the criteria on the set of code ranks 222 are provided, for example, in FIG. 3 and FIG. 4.

At 916, the second set of actions 216B is selected from the set of actions 216 based on the application of the criteria on the set of code ranks 222. In an embodiment of the disclosure, the computer system 202 is configured to select the second set of actions 216B from the set of actions 216 based on the application of the criteria on the set of code ranks 222. Details about the selection of the second set of actions 216B from the set of actions 216 are provided, for example, in FIG. 3 and FIG. 4.

At 918, a source code of the set of source codes 218 is executed to execute the set of tasks 214 associated with the planning problem. The source code is associated with the selected second set of actions 216B. In an embodiment of the disclosure, the computer system 202 is configured to execute the source code of the second set of source codes 218. Details about the execution of the source code of the set of source codes 218 are provided, for example, in FIG. 3 and FIG. 4.

While the above operations shown in FIG. 9 are described in a particular sequence, the operations may occur in variations to the sequence in accordance with various embodiments of the present disclosure. Further, details related to various operations of FIG. 9 which are already covered in the description related to FIG. 1, FIG. 2, FIG. 3, FIG. 4, FIG. 5, FIG. 6A, FIG. 6B, FIG. 7, and FIG. 8 are not discussed again in detail here for the sake of brevity.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the embodiments described. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
executing, by a computer, a first set of actions of a set of actions to achieve an objective associated with a planning problem;
applying, by the computer, a machine learning model on each action of the set of actions;
generating, by the computer, a set of source codes corresponding to each action of the set of actions based on the application of the machine learning model on each action of the set of actions;
determining, by the computer, a set of complexity scores based on each source code of the set of source codes, wherein each complexity score of the set of complexity scores is indicative of a computational complexity of a corresponding source code of the set of source codes;
applying, by the computer, criteria on the set of complexity scores, wherein the criteria are associated with a likelihood of execution of a second set of actions of the set of actions subsequent to the first set of actions;
selecting, by the computer, the second set of actions from the set of actions based on the application of the criteria on the set of complexity scores; and
executing, by the computer, a source code of the set of source codes to execute a set of tasks associated with the planning problem, wherein the source code is associated with the selected second set of actions.

2. The computer-implemented method of claim 1, wherein the application of the criteria on the set of complexity scores further comprising:
comparing, by the computer, each complexity score of the set of complexity scores with a complexity score threshold;
determining, by the computer, that at least one complexity score of the set of complexity scores is less than the complexity score threshold based on the comparison of each complexity score of the set of complexity scores with the complexity score threshold; and
selecting, by the computer, the second set of actions associated with the source code of the at least one complexity score based on the determination that the at least one complexity score of the set of complexity scores is less than the complexity score threshold.

3. The computer-implemented method of claim 1, further comprising:
determining, by the computer, source code data associated with each source code of the set of source codes, wherein the source code data comprises at least one of an identifier of each source code of the set of source codes, a number of code lines of each source code of the set of source codes, a count of code blocks of each source code of the set of source codes, a count of conditional blocks of each source code of the set of source codes, an amount of memory for execution of each source code of the set of source codes, or a set of total time periods for the execution of each source code of the set of source codes;
generating, by the computer, a code complexity evaluation function based on a set of complexity factors associated with the source code data;
executing, by the computer, the code complexity evaluation function based on the source code data; and
determining, by the computer, the set of complexity scores based on the execution of the code complexity evaluation function.

4. The computer-implemented method of claim 3, wherein the set of complexity factors comprises at least one of a normalization factor associated with the number of code lines of each source code of the set of source codes, a normalization factor associated with the count of code blocks of each source code of the set of source codes, a normalization factor associated with the count of conditional blocks of each source code of the set of source codes, a normalization factor associated with the amount of memory for the execution of each source code of the set of source codes, or a normalization factor associated with the set of total time periods for the execution of each source code of the set of source codes.

5. The computer-implemented method of claim 1, further comprising:
determining, by the computer, a set of code ranks based on the set of complexity scores, wherein the set of code ranks is indicative of an order of the computational complexity associated with the corresponding source code of the set of source codes;
applying, by the computer, the criteria on the set of code ranks; and
selecting, by the computer, the second set of actions from the set of actions based on the application of the criteria on the set of code ranks.

6. The computer-implemented method of claim 5, wherein the application of the criteria on the set of code ranks further comprising:
comparing, by the computer, each code rank of the set of code ranks with a code rank threshold;
determining, by the computer, that at least one code rank of the set of code ranks is greater than the code rank threshold based on the comparison of each code rank of the set of code ranks with the code rank threshold; and
selecting, by the computer, the second set of actions associated with the source code of the at least one code rank based on the determination that the at least one code rank of the set of code ranks is greater than the code rank threshold.

7. The computer-implemented method of claim 5, further comprising:
generating, by the computer, a ranking function based on a scaling factor associated with the set of complexity scores;
executing, by the computer, the ranking function based on the set of complexity scores; and
determining, by the computer, the set of code ranks based on the execution of the ranking function.

8. The computer-implemented method of claim 7, wherein the scaling factor corresponds to one of a normalization factor associated with a normalization of the set of complexity scores, a normalization factor associated with a mean of the set of complexity scores, a normalization factor associated with a standard deviation of the set of complexity scores, or a normalization factor associated with a log of the set of complexity scores.

9. The computer-implemented method of claim 5, further comprising:
receiving, by the computer, at least one action of the set of actions executed subsequent to the first set of actions, wherein the second set of actions comprises the at least one action of the set of actions;
determining, by the computer, an action of the second set of actions corresponding to a first code rank of the set of code ranks;
comparing, by the computer, the at least one action of the set of actions with the action of the second set of actions;
determining, by the computer, validation data for the at least one action of the set of actions based on the comparison of the at least one action of the set of actions with the action of the second set of actions, wherein the validation data is associated with at least a classification of an accuracy of the at least one action associated with the objective; and
outputting, by the computer, the validation data.

10. The computer-implemented method of claim 9, further comprising:
generating, by the computer, training data based on the validation data; and
training, by the computer, a machine learning model based on the training data, wherein the machine learning model is trained to determine the second set of actions.

11. A computer system, comprising:
a processor set;
one or more computer-readable storage media; and
program instructions stored on the one or more computer-readable storage media, the program instructions executable by the processor set to cause the processor set to:
execute a first set of actions of a set of actions to achieve an objective associated with a planning problem;
apply a machine learning model on each action of the set of actions;
generate a set of source codes corresponding to each action of the set of actions based on the application of the machine learning model on each action of the set of actions;
determine a set of complexity scores based on each source code of the set of source codes, wherein each complexity score of the set of complexity scores is indicative of a computational complexity of the corresponding source code of the set of source codes;
determine a set of code ranks based on the set of complexity scores, wherein the set of code ranks is indicative of an order of the computational complexity associated with the corresponding source code of the set of source codes;
apply criteria on the set of code ranks, wherein the criteria are associated with a likelihood of execution of a second set of actions of the set of actions subsequent to the first set of actions;
select the second set of actions from the set of actions based on the application of the criteria on the set of code ranks; and
execute a source code of the set of source codes to execute a set of tasks associated with the planning problem, wherein the source code is associated with the selected second set of actions.

12. The computer system of claim 11, wherein the program instructions further cause the processor set to:
determine source code data associated with each source code of the set of source codes, wherein the source code data comprises at least one of an identifier of each source code of the set of source codes, a number of code lines of each source code of the set of source codes, a count of code blocks of each source code of the set of source codes, a count of conditional blocks of each source code of the set of source codes, an amount of memory for execution of each source code of the set of source codes, or a set of total time periods for the execution of each source code of the set of source codes;
generate a code complexity evaluation function based on a set of complexity factors associated with the source code data;
execute the code complexity evaluation function based on the source code data; and
determine the set of complexity scores based on the execution of the code complexity evaluation function.

13. The computer system of claim 12, wherein the set of complexity factors comprises at least one of a normalization factor associated with the number of code lines of each source code of the set of source codes, a normalization factor associated with the count of code blocks of each source code of the set of source codes, a normalization factor associated with the count of conditional blocks of each source code of the set of source codes, a normalization factor associated with the amount of memory for the execution of each source code of the set of source codes, or a normalization factor associated with the set of total time periods for the execution of each source code of the set of source codes.

14. The computer system of claim 11, wherein to apply the criteria on the set of code ranks, the program instructions further cause the processor set to:
compare each code rank of the set of code ranks with a code rank threshold;
determine that at least one code rank of the set of code ranks is greater than the code rank threshold based on the comparison of each code rank of the set of code ranks with the code rank threshold; and
select the second set of actions associated with the source code of the at least one code rank based on the determination that the at least one code rank of the set of code ranks is greater than the code rank threshold.

15. The computer system of claim 11, wherein the program instructions further cause the processor set to:
generate a ranking function based on a scaling factor associated with the set of complexity scores;
execute the ranking function based on the set of complexity scores; and
determine the set of code ranks based on the execution of the ranking function.

16. The computer system of claim 15, wherein the scaling factor corresponds to one of a normalization factor associated with a normalization of the set of complexity scores, a normalization factor associated with a mean of the set of complexity scores, a normalization factor associated with a standard deviation of the set of complexity scores, or a normalization factor associated with a log of the set of complexity scores.

17. The computer system of claim 15, wherein the program instructions further cause the processor set to:
receive at least one action of the set of actions executed subsequent to the first set of actions, wherein the second set of actions comprises the at least one action of the set of actions;
determine an action of the second set of actions corresponding to a first code rank of the set of code ranks;
compare the at least one action of the set of actions with the action of the second set of actions;
determine validation data for the at least one action of the set of actions based on the comparison of the at least one action of the set of actions with the action of the second set of actions, wherein the validation data is associated with at least a classification of an accuracy of the at least one action associated with the objective; and
output the validation data.

18. The computer system of claim 17, wherein the program instructions further cause the processor set to:
generate training data based on the validation data; and
train the machine learning model based on the training data, wherein the machine learning model is trained to determine the second set of actions.

19. A computer program product for selection of actions associated with a planning problem, the computer program product comprising:
one or more computer-readable storage media; and
program instructions stored on the one or more computer-readable storage media to perform operations comprising:
executing a first set of actions of a set of actions to achieve an objective associated with the planning problem;
applying a machine learning model on each action of the set of actions;
generating a set of source codes corresponding to each action of the set of actions based on the application of the machine learning model on each action of the set of actions;
determining a set of complexity scores based on each source code of the set of source codes, wherein each complexity score of the set of complexity scores is indicative of a computational complexity of the corresponding source code of the set of source codes;
applying criteria on the set of complexity scores, wherein the criteria are associated with a likelihood of execution of a second set of actions of the set of actions subsequent to the first set of actions;
selecting the second set of actions from the set of actions based on the application of the criteria on the set of complexity scores; and
executing a source code of the set of source codes to execute a set of tasks associated with the planning problem, wherein the source code is associated with the selected second set of actions.

20. The computer program product of claim 19, wherein the program instructions stored on the one or more computer-readable storage media perform the operations further comprising:
comparing each complexity score of the set of complexity scores with a complexity score threshold;
determining that at least one complexity score of the set of complexity scores is less than the complexity score threshold based on the comparison of each complexity score of the set of complexity scores with the complexity score threshold; and
selecting the second set of actions associated with the source code of the at least one complexity score based on the determination that the at least one complexity score of the set of complexity scores is less than the complexity score threshold.
